(19) United States
(12) Patent Application Publication
(10) Pub. No.: US 2024/0217361 A1
(43) Pub. Date: Jul. 4, 2024

(54) Electric Vehicle Charging Methods and Systems

(71) Applicant: FREEWIRE TECHNOLOGIES, INC., Newark, CA (US)

(72) Inventor: Christopher William Ledesma, San Francisco, CA (US)

(21) Appl. No.: 18/404,675

(22) Filed: Jan. 4, 2024

Related U.S. Application Data
(60) Provisional application No. 63/436,997, filed on Jan. 4, 2023.

(51) Int. Cl. B60L 53/34; B60L 53/35

(52) U.S. Cl. CPC B60L 53/34; B60L 53/35; B60L 53/18

(57) ABSTRACT

A holster for an electric charging station includes a substantially rigid base and a socket pivotably disposed in the substantially rigid base. The socket has a first, stowed position and a second, engaged position. The socket pivots about a loaded hinge. A biasing spring, which may be a leaf spring, produces a first force that urges the socket towards the first, stowed position. When an electric power coupler is disposed within the socket, a second force overcomes the first force and moves the socket towards the second, engaged position.

### TECHNICAL FIELD

At least one aspect generally relates to improvements to vehicle charging stations generally and more particularly to improvements in quickly and efficiently connecting an electric power coupler to a charging socket of a charging holster.

### BACKGROUND

The growing use of electric vehicles is causing an increased need and use of electric vehicle charging stations. Effective, economical, and rapid deployment of electric vehicle charging stations requires solutions to problems which have as yet not been solved. The present inventors have developed one or more solutions that may address one or more problems related to electric vehicle charging stations and electric vehicle charging equipment.

### SUMMARY

A first aspect of the present invention pertains to a holster for an electric charging station, the holster including a substantially rigid base and a socket pivotably disposed in the substantially rigid base such that the socket has a first, stowed position and a second, engaged position. The socket pivots about a loaded hinge. A biasing spring produces a first force that urges the socket towards the first, stowed position.

The foregoing first aspect may include one or more of the following optional forms. In one optional form, the biasing spring is a leaf spring.

In another optional form, a guide slot is disposed in the substantially rigid base and a guide nut is attached to the socket, the guide nut being at least partially disposed within the guide slot.

In another optional form, the guide slot is curved.

In another optional form, the guide slot has a radius of curvature having its center co-located with the loaded hinge.

In another optional form, the guide nut includes a nut slot and the leaf spring is at least partially disposed in the nut slot.

In another optional form, the leaf spring is slidably disposed in the nut slot.

In another optional form, the holster includes a locking ledge.

In another optional form, an electric power coupler is at least partially disposed within the socket and the electric power coupler creates a second force, that is greater than the first force, which causes the socket to pivot about the loaded hinge, towards a second, engaged position.

In another optional form, the electric power coupler includes a lock that engages a locking ledge when the electric power coupler is disposed in the socket.

In another optional form, the socket is one of translucent and transparent.

In another optional form, a light source is capable of illuminating the socket.

In another optional form, a sensor detects a position of the holster within the substantially rigid base.

In another optional form, the sensor is operatively connected to a controller.

Another aspect of the present invention pertains to an electric vehicle charging station having a main housing, an electric charger connector and a charger cable attached to the main housing, a controller, a user interface disposed in the main housing and operatively connected to the controller, and a holster disposed in the main housing. The holster includes a substantially rigid base and a socket pivotably disposed in the substantially rigid base. The socket has a first, stowed position and a second, engaged position. The socket pivots about a loaded hinge. A leaf spring produces a first force that urges the socket towards the first, stowed position.

The foregoing second aspect may include any one or more of the following optional forms.

In one optional form, a sensor detects the position of the holster and communicates the position of the holster to the controller.

In another optional form, when the electric power coupler is disposed in the holster, a weight of the electric power coupler creates a second force, that is greater than the first force, the second force urging the socket to move towards the second, engaged position.

In another optional form, a guide slot is disposed in the substantially rigid base and a guide nut attached to the socket. The guide nut is at least partially disposed within the guide slot.

A third aspect of the present invention pertains to a system comprising a plurality of direct current (DC) power sources. The system includes a network of contactors and wiring connected with the DC power sources to provide an output power. The system also includes a controller in communication with the network of contactors to open and close the contactors to accomplish parallel circuits, series circuits, or combinations thereof for the positive terminal and the negative terminal of the DC power sources to provide two or more voltages for the output power of the system.

It is to be understood that the invention is not limited in its application to the details of construction and to the arrangements of the components set forth in the following description. The invention is capable of other embodiments and of being practiced and carried out in various ways. In addition, it is to be understood that the phraseology and terminology employed herein are for the purpose of description and should not be regarded as limiting.

### BRIEF DESCRIPTION OF THE DRAWINGS

FIG. 1 is a box diagram according to one or more embodiments of the present invention.

FIG. 1-1 is a box diagram according to one or more embodiments of the present invention.

FIG. 1-2 is a box diagram according to one or more embodiments of the present invention.

FIG. 1-3 is a box diagram according to one or more embodiments of the present invention.

FIG. 1-4 is a box diagram according to one or more embodiments of the present invention.

FIG. 1-5 is a box diagram according to one or more embodiments of the present invention.

FIG. 1-6 is a diagram according to one or more embodiments of the present invention.

FIG. 2 is a box diagram according to one or more embodiments of the present invention.

FIG. 2-1 is a perspective view according to one or more embodiments of the present invention.

FIG. 2-2 is a perspective view according to one or more embodiments of the present invention used to charge an electric vehicle.

FIG. 3 is a diagram according to one or more embodiments of the present invention.

FIG. 4 is a diagram according to one or more embodiments of the present invention.

FIG. 5 is a diagram of a process flow according to one or more embodiments of the present invention.

FIG. 5-1 is a diagram of a process flow according to one or more embodiments of the present invention.

FIG. 5-2 is a continuation of the process flow of FIG. 5-1.

FIG. 5-3 is a continuation of the process flow of FIG. 5-1.

FIG. 6 is a perspective view of a charging station according to one or more embodiments of the present invention.

FIG. 7 is a perspective view of a charging station according to one or more embodiments of the present invention.

FIG. 8 is a perspective close up view of a holster of a charging station according to one or more embodiments of the present invention.

FIG. 9 is a perspective view of the holster of FIG. 8 removed from a housing of the charging station and a socket in a first, stowed position.

FIG. 10 is a side view of the holster of FIG. 9.

FIG. 11 is a perspective view of the holster of FIG. 8, with the socket in a second, engaged position.

FIG. 12 is a perspective cut-away view of the holster of FIG. 8, illustrating some surrounding structure of the charging station.

FIG. 13 is a side perspective view of another embodiment of a holster, the holster including a tension/compression spring.

FIG. 14 is a side perspective view of yet another embodiment of a holster, the holster including a constant force spring.

Skilled artisans appreciate that elements in the figures are illustrated for simplicity and clarity and have not necessarily been drawn to scale. For example, the dimensions of some of the elements in the figures may be exaggerated relative to other elements to help to improve understanding embodiments of the present invention.

### DETAILED DESCRIPTION

In the following description of the figures, identical reference numerals have been used when designating substantially identical elements or processes that are common to the figures.

Unless otherwise defined, all technical and scientific terms used herein have the same meaning as commonly understood by one of ordinary skill in the art to which this invention belongs. In case of conflict with publications, patent applications, patents, and other references mentioned incorporated herein by reference, the present specification, including definitions, will control.

Various embodiments the present invention may include any of the illustrated or described features of any embodiment, alone or in combination. Other features and/or benefits of this disclosure will be apparent from the following description.

All numeric values are herein defined as being modified by the term “about,” whether or not explicitly indicated. The term “about” generally refers to a range of numbers that a person of ordinary skill in the art would consider equivalent to the stated value to produce substantially the same properties, function, result, etc. A numerical range indicated by a low value and a high value is defined to include all numbers subsumed within the numerical range and all subranges subsumed within the numerical range. As an example, the range 10 to 15 includes, but is not limited to, 10, 10.1, 10.47, 11, 11.75 to 12.2, 12.5, 13 to 13.8, 14, 14.025, and 15.

The order of execution or performance of the operations or the processes in embodiments of the invention illustrated and described herein is not essential, unless otherwise specified. That is, the operations or the processes may be performed in any order, unless otherwise specified, and embodiments of the invention may include additional or fewer operations or processes than those disclosed herein. For example, it is contemplated that executing or performing a particular operation or process before, simultaneously with, contemporaneously with, or after another operation or process is within the scope of aspects of the invention.

As will be understood by a person skilled in the art, aspects of the present invention may be embodied as a system, method, a computer program product, or combinations thereof. Accordingly, aspects of the present invention may take the form of an entirely hardware embodiment, an entirely software embodiment (including firmware, resident software, micro-code, etc.) or an embodiment combining software and hardware aspects that may all generally be referred to herein as an “apparatus”, a “circuit,” a “module” or a “system.” Furthermore, aspects of the present invention may take the form of a computer program product embodied in one or more non-transitory computer readable medium(s) having computer readable program code embodied, e.g., stored, thereon.

Any combination of one or more non-transitory computer readable mediums may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java™, Smalltalk, C++ or the like and conventional procedural programming languages, such as the “C” programming language, such as .net framework and Microsoft Corporation programming languages and databases, such as HTML5, Android Mobile applications and Apple Corporation iOS mobile applications, or similar programming languages. The program code may execute entirely on a local computer, partly on the local computer, as a stand-alone software package, partly on the local computer and partly on a remote computer, or entirely on the remote computer or server. In the latter scenario, the remote computer may be connected to the local computer through any type of network, including a local area network (LAN) or a wide area network (WAN), or the connection may be made to an external computer (for example, through the Internet using an Internet Service Provider). The program code may reside on remote servers and software networks such as for cloud computing such as, but not limited to, Amazon Web Services, Google cloud etc. Mobile applications of the program code may also be available for download from services such as Apple App store and Google play.

Aspects of the present invention are described below with reference to flowchart illustrations and/or block diagrams of methods, processes, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions which execute via the processor of the computer, other programmable data processing apparatus, or other devices enable implementation of the functions/acts specified in the flowchart and/or block diagram block or blocks.

These computer program instructions may also be stored in a non-transitory computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The following description is primarily directed towards electric energy systems for providing electric power for conductive charging drive batteries of electric vehicles, such as, but not limited to, electric automobiles. It is to be understood that one or more embodiments of the present invention apply to other electric vehicles such as, but not limited to, electric trucks, electric vans, electric buses, electric bikes, electric motorcycles, electric boats, and electric airplanes. In addition, is to be understood that one or more embodiments of the present invention apply to charging batteries for applications other than for electric vehicles such as but not limited to backup power systems.

One aspect of the present invention pertains to a system for transferring electric power using a range of selectable voltages or power levels. In one example embodiment, the system is used to accomplish charging electric vehicles. Another embodiment includes a system configured to provide electric power for energy storage devices such as batteries. Another embodiment includes a system configured to provide electric power for performing a real-time process or operation.

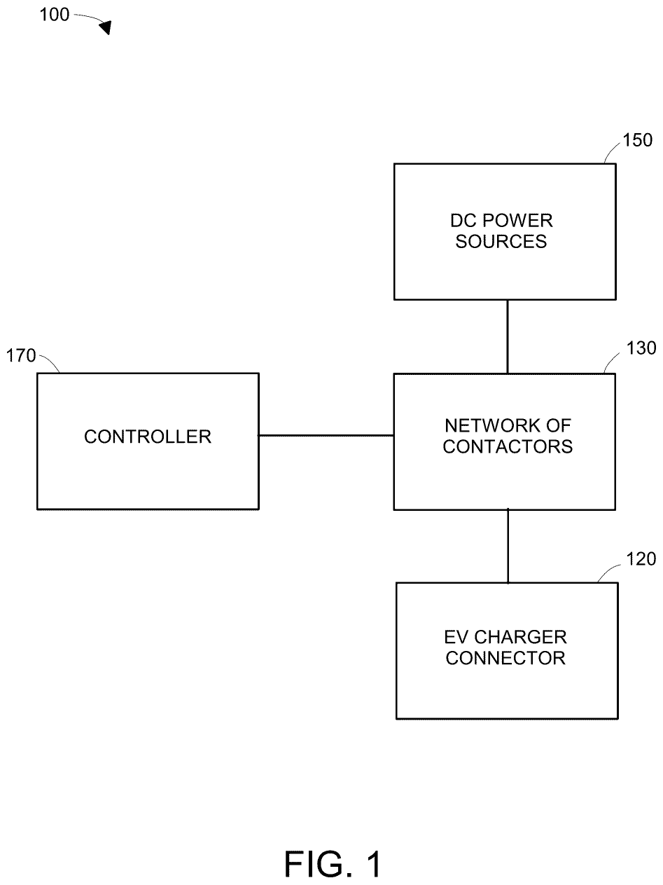

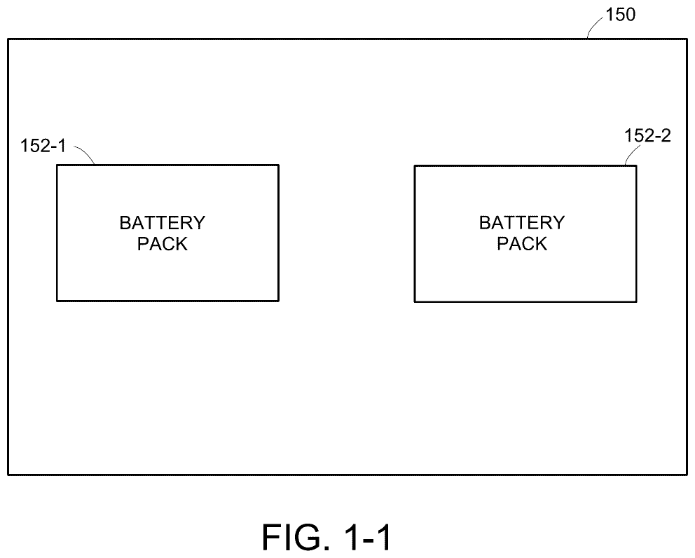

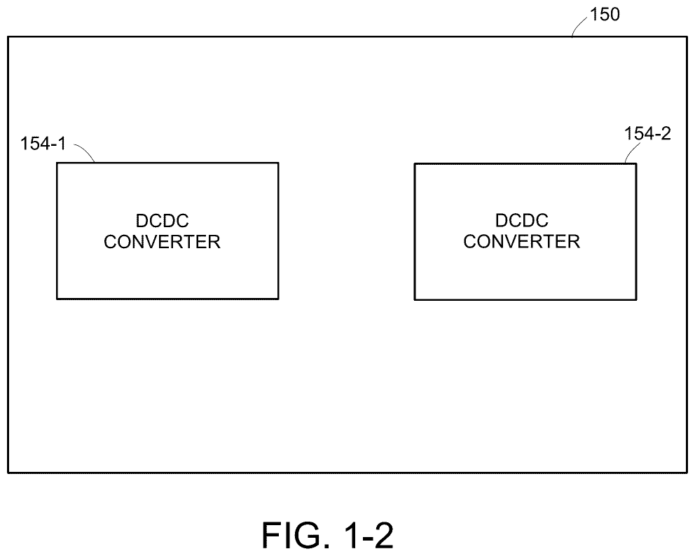

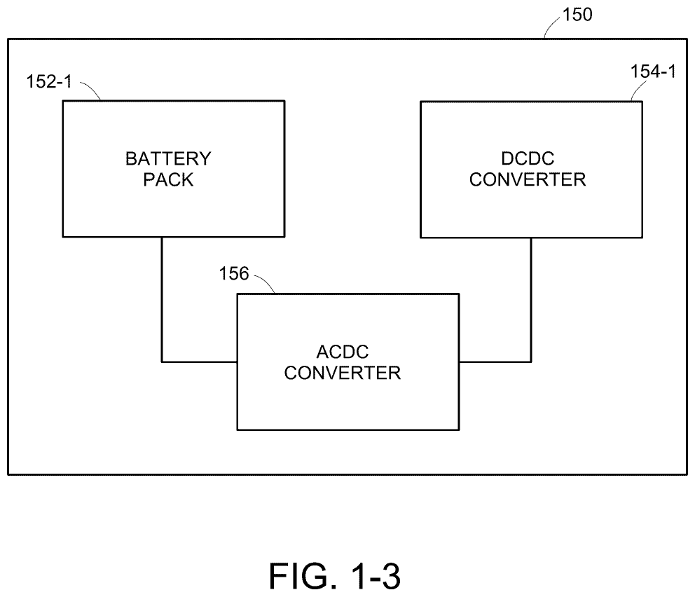

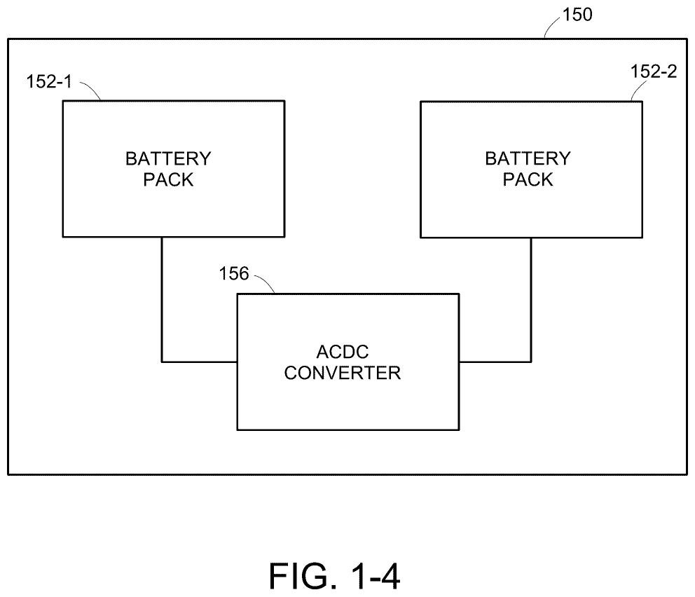

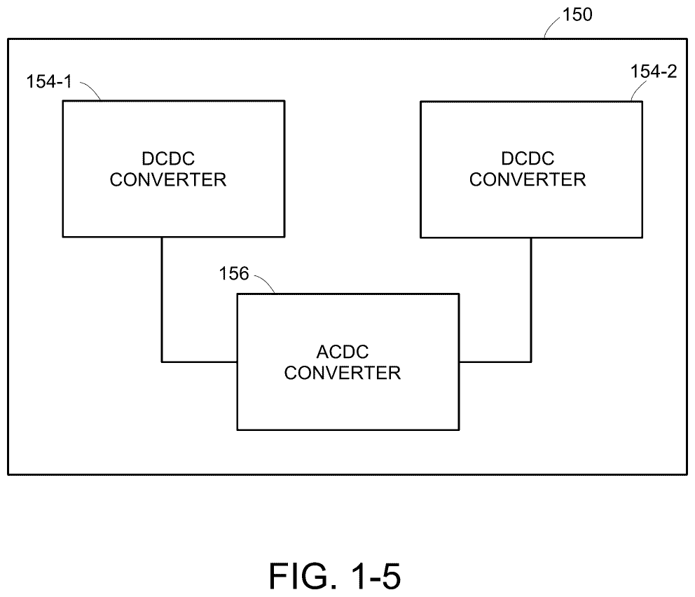

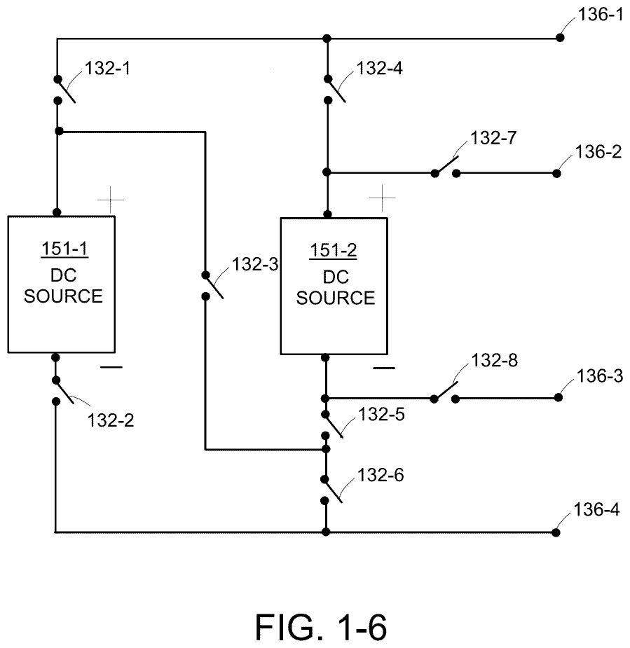

Reference is now made to FIG. 1 where there is shown a box diagram of a system 100 according to one or more embodiments of the present invention. The embodiment shown in FIG. 1 is directed towards an embodiment for charging electric vehicles for which the option of including an electric vehicle charger connector 120 is shown in FIG. 1. Other embodiments of system 100 may include other types of connectors as is understood by persons of ordinary skill in the art in view of the present disclosure. FIG. 1 shows system 100 comprising a plurality of DC power sources 150, each of DC power sources 150 having a positive terminal and a negative terminal. System 100 includes a network of wired contactors 130 connected with a positive terminal and a negative terminal of the plurality of DC power sources 150 to provide an output power. System 100 also includes a controller 170 in communication with the network of contactors 130 to open and close the contactors to accomplish parallel circuits, series circuits, or combinations thereof for the positive terminal and the negative terminal of the plurality of DC power sources 150 to provide two or more selectable voltages for the output power of system 100.

Embodiments of the present invention may include a variety of configurations. For instance, embodiments of the present invention may be configured as a mobile electric vehicle charger such as electric vehicle chargers described in U.S. Pat. No. 9,592,742, the entirety of which is hereby incorporated by reference. As another option, embodiments of the present invention may be configured as stationary electric vehicle chargers. As another option, embodiments of the present invention may be configured as portable electric vehicle chargers. Optionally, embodiments of the present invention may include two or more charging connectors.

In other words, system 100 comprises a network of wired contactors 130, a plurality of DC power sources 150, and a controller 170. The plurality of DC power sources 150 comprises two or more DC power sources and each of DC power sources having a positive terminal and a negative terminal such as a high voltage side and a low voltage side. Network of wired contactors 130 is connected with a positive terminal and a negative terminal of DC power sources 150 to provide an output power such as for charging one or more electric vehicles. Controller 170 is connected with network of wired contactors 130 to open and close the contactors to accomplish parallel circuits, series circuits, or combinations thereof for the positive terminal and the negative terminal of the DC power sources to provide two or more selectable voltages for the output power so that different voltages may be used to charge electric vehicles.

The plurality of DC power sources 150 may comprise essentially any type of DC power supply. Examples of suitable DC power supplies may include, but are not limited to, secondary battery cells, lead acid battery cells, lithium-ion battery cells, lithium battery cells, a DC generator, a flow battery, a fuel cell, metal air battery cells photovoltaic panels, or combinations thereof. As another option, plurality of DC power supplies 150 may comprise an alternating current direct current (ACDC) converter. The ACDC converter may be connected to a power source such as for example, an electric grid.

Controller 170 may comprise a variety of devices such as, but not limited to, a computer, a central processor, a memory, an application specific integrated circuit, or combinations thereof. Controller 170 may also comprise a computer program product for controlling contactor states such as by turning them on or off. The computer program product may be embodied in a non-transitory computer readable medium and comprise computer instructions for controlling the contactors. Optionally, the non-transitory computer readable medium may reside entirely on system 100 or at a remote location such as a network location, a cloud storage location, a network server, or combinations thereof.

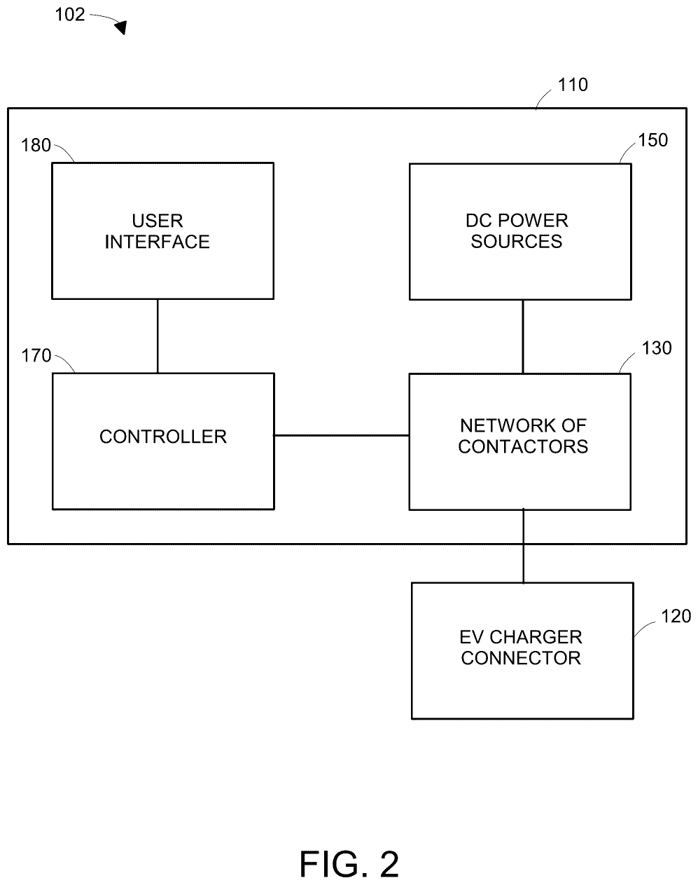

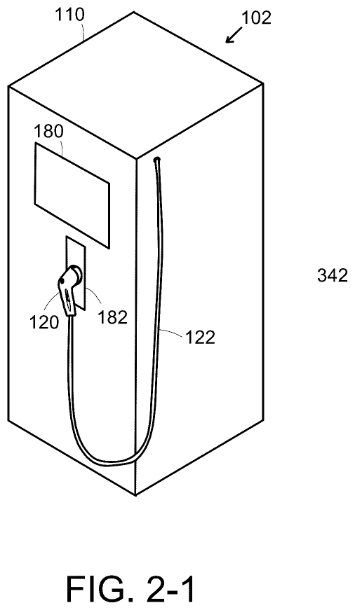

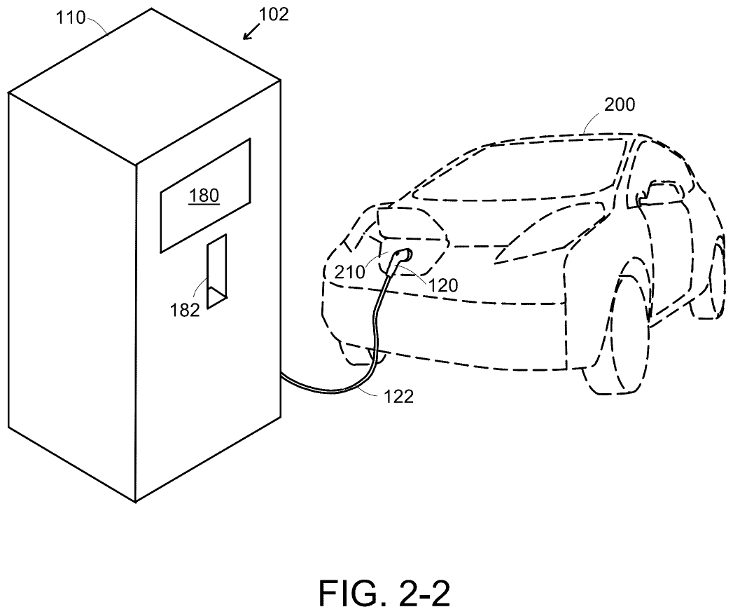

Reference is now made to FIG. 1-1, FIG. 1-2, and FIG. 1-3 where there are shown examples of box diagrams for one or more embodiments of plurality of DC power sources 150. FIG. 1-1 shows an embodiment of plurality of DC power sources 150 comprising a battery pack 152-1 and a battery pack 152-2. Battery pack 152-1 and battery pack 152-2 may comprise any type of battery cells that are compatible for forming circuits. FIG. 1-2 shows an embodiment of plurality of DC power sources 150 comprising a DCDC converter 154-1 and a DCDC converter 154-2. Examples of DCDC converters for one or more embodiments of the present invention include, but are not limited to, buck converters, boost converters, buck boost converters, reversible converters, bidirectional converters, bidirectional buck converters, bidirectional boost converters, and bidirectional buck boost converters. FIG. 1-3 shows an embodiment of plurality of DC power sources 150 that includes battery pack 152-1, DCDC converter 154-1, and an ACDC converter 156. ACDC converter 156 may be connected with an energy source such as, but not limited to, an electric grid. ACDC converter 156 is connected with battery pack 152-1 and DCDC converter 154-1 to provide a DC power input which may be used to charge battery pack 152-1 and/or provide a DC power input for conversion by DCDC converter 154-1.

Reference is now made to FIG. 1-4 where there is shown plurality of DC power sources 150 comprising battery pack 152-1, battery pack 152-2, and ACDC converter 156 connected to recharge battery pack 152-1 and battery pack 152-2.

Reference is now made to FIG. 1-5 where there is shown plurality of DC power sources 150 comprising DCDC converter 154-1, DCDC converter 154-2, and ACDC converter 156 connected to provide DC power input for conversion by DCDC converter 154-1 and a DCDC converter 154-2.

Reference is now made to FIG. 1-6 where there is shown an embodiment of the present invention comprising a plurality of DC power sources comprising DC source 151-1 and DC source 151-2. DC source 151-1 and DC source 151-2 are shown having positive and negative terminals. FIG. 1-6 also shows a network of wired contactors including contactors 132-1, 132-2, 132-3, 132-4, 132-5, 132-6, 132-7, and 132-8. The network of wired contactors are connected with DC source 151-1 and DC source 151-2 so that selecting the open and closed states of the contactors can accomplish independent power distribution, parallel power distribution, or series power distribution for a range of output power voltages. More specifically, circuits can be established to provide two or more different output voltages that can be selected by changing the circuit configuration. According to one embodiment of the present invention, a controller such as controller 170 (not shown in FIG. 1-6) is provided connected with the network of wired contactors to select the configuration of the circuits in terms of which contactors are open and which contactors are closed. According to one or more embodiments of the present invention, the contactors may be any contactor suitable for applications such as for electric vehicle charging. For one or more embodiments of the present invention, the contactors use solid state transistors such as silicon carbide contractors.

The embodiment shown in FIG. 1-6 can selectively have a circuit for which power is only drawn from DC source 151-1 such as for example having contactors 132-1 and 132-2 turned ON and contactors 132-3, 132-4, 132-5, 132-6, 132-7, and 132-8 turned OFF to transfer power via terminals 136-1 and 136-4. The embodiment shown in FIG. 1-6 can selectively have a circuit for which power is only drawn from DC source 151-2 such as for example having contactors 132-7 and 132-8 turned ON and contactors 132-1, 132-2, 132-3, 132-4, 132-5, and 132-6 turned OFF to transfer power via terminals 136-2 and 136-3. The embodiment shown in FIG. 1-6 can selectively have a circuit for which power is drawn independently from DC source 151-1 and drawn independently from DC source 151-2 simultaneously. The embodiment shown in FIG. 1-6 can selectively have a circuit for which power is drawn from DC source 151-1 and drawn from DC source 151-2 connected in parallel. The embodiment shown in FIG. 1-6 can selectively have a circuit for which power is drawn from DC source 151-1 and drawn from DC source 151-2 connected in series. Other embodiments of the present invention which may include more than two DC sources and additional contactors to allow providing power at additional voltages based on the selected circuits so that an even larger range of voltages are selectable.

The embodiment in FIG. 1-6 shows an example configuration that provides additional options for charging DC source 151-1 and DC source 151-2 when they comprise secondary batteries. For instance, the charging of the batteries can be accomplished independently for each battery, the batteries connected in series, the batteries connected in parallel, or combinations thereof.

According to one embodiment of the present invention, the plurality of DC power sources 150 comprises secondary battery cells. According to another embodiment of the present invention, plurality of DC power sources 150 comprises lithium ion battery cells. According to another embodiment of the present invention, plurality of DC power sources 150 comprises lithium battery cells. According to another embodiment of the present invention, plurality of DC power sources 150 comprises a DC generator, a flow battery, a fuel cell, a photovoltaic panel, or combinations thereof. According to another embodiment of the present invention, plurality of DC power sources 150 comprises a secondary battery, a DC generator, a photovoltaic panel, or combinations thereof.

According to another embodiment of the present invention, system 100 further comprises an electric grid connected ACDC converter and wherein the plurality of DC power sources comprise at least one secondary battery, the ACDC converter being connected with the at least one secondary battery to charge the secondary battery.

According to another embodiment of the present invention, system 100 further comprises an ACDC converter and wherein the plurality of DC power sources comprises at least one secondary battery, the ACDC converter being connected with the at least one secondary battery to charge the secondary battery, wherein the network of contactors provides connections from the output of the ACDC converter to charge the at least one secondary battery.

According to another embodiment of the present invention, system 100 further comprises an ACDC converter and wherein the plurality of DC power sources comprises at least one secondary battery, the ACDC converter being connected with the at least one secondary battery to charge the secondary battery, wherein the network of contactors provides connections from the output of the ACDC converter to charge the at least one secondary battery while power is also drawn from the at least one secondary battery to charge the electric vehicle.

According to another embodiment of the present invention, system 100 further comprises an ACDC converter and wherein the plurality of DC power sources comprises at least one DCDC converter, the ACDC converter being connected to provide DC power input to the at least one DCDC converter.

According to another embodiment of the present invention, system 100 further comprises an ACDC converter and wherein the plurality of DC power sources comprises at least one DCDC converter and at least one secondary battery, ACDC converter being connected to provide DC power input to the at least one DCDC converter, DC power input to the at least one secondary battery, or combinations thereof.

According to another embodiment of the present invention, system 100 further comprises an ACDC converter and further comprising at least one DCDC converter; the plurality of DC power sources comprising at least one secondary battery, the ACDC converter being connected to charge the at least one secondary battery; the plurality of DC power sources being connected to provide DC power input to the at least one DCDC converter, and the at least one DCDC converter being connected to provide the output power to charge the electric vehicle.

According to another embodiment of the present invention, system 100 further comprises a buck converter connected with the output of the plurality of DC power sources to reduce the voltage available to charge the electric vehicle.

According to another embodiment of the present invention, system 100 further comprises a boost converter connected with the output of the plurality of DC power sources to increase the voltage available to charge the electric vehicle.

According to another embodiment of the present invention, controller 170 comprises executable code to select or design contactor states to provide the circuitry for the plurality of DC power sources for a requested output charging voltage.

According to another embodiment of the present invention, controller 170 comprises a computer memory containing data for a look-up table relating selectable voltages with contactor states to provide the circuitry for the plurality of DC power sources for a requested output charging voltage.

According to another embodiment of the present invention, system 100 provides two or more selectable voltages for the output power to charge an electric vehicle and the voltages are equal or greater than 400 VDC.

According to another embodiment of the present invention, system 100 provides two or more selectable voltages for the output power to charge an electric vehicle and the voltages are about 400 VDC or about 700 VDC.

According to another embodiment of the present invention, system 100 provides two or more selectable voltages for the output power to charge an electric vehicle and the voltages are from about 200 VDC to about 1000 VDC and all values, ranges, and subranges subsumed therein.

According to another embodiment of the present invention, plurality of DC power sources 150 comprise electrical grid connected ACDC converter, buck converter, boost converter, buck-boost converter, or combinations thereof.

According to another embodiment of the present invention, system 100 further comprises a housing 110 and/or a user interface 180 as shown in FIG. 2, FIG. 2-1, and FIG. 2-2 for system 102. FIG. 2 shows a block diagram for system 102 such as for an electric vehicle charging station. FIG. 2-1 shows a perspective view of system 102 according to one embodiment of the present invention. The embodiment shown in FIG. 2-1 and FIG. 2-2 includes housing 110 to which is attached user interface 180 which may include a display with touchscreen or other type of user interface. Also shown are charging connector 120 and charging cable 122. Charging cable 122 provides electrical power transfer to charging connector 120 such as when charging connector 120 is connected with an electric vehicle 190 charging port 192 as shown as an example in FIG. 2-2. According to one or more embodiments of the present invention, system 100 may have two or more charging cables and charging connectors so as to charge two or more electric vehicles at the same time. System 102 also includes a holster 182 incorporated with housing 110 for holding charging connector 120 such as when charging connector 120 is not in use for charging an electric vehicle.

According to one or more embodiments of the present invention, a variety of choices may be made for charging connector 120 for applications such as charging electric vehicles. According to one embodiment of the present invention, system 100 comprises at least one fast charging connector wherein the at least one fast charging connector receives a voltage for fast charging the electric vehicle. According to one embodiment of the present invention, system 100 comprises at least two DC fast charging connectors. Examples of fast charging connectors for one or more embodiments of the present invention include, but are not limited to, the Combined Charging System (CCS) connectors Combo 1 and Combo 2, and the CHArge de MOve (CHAdeMO) connector.

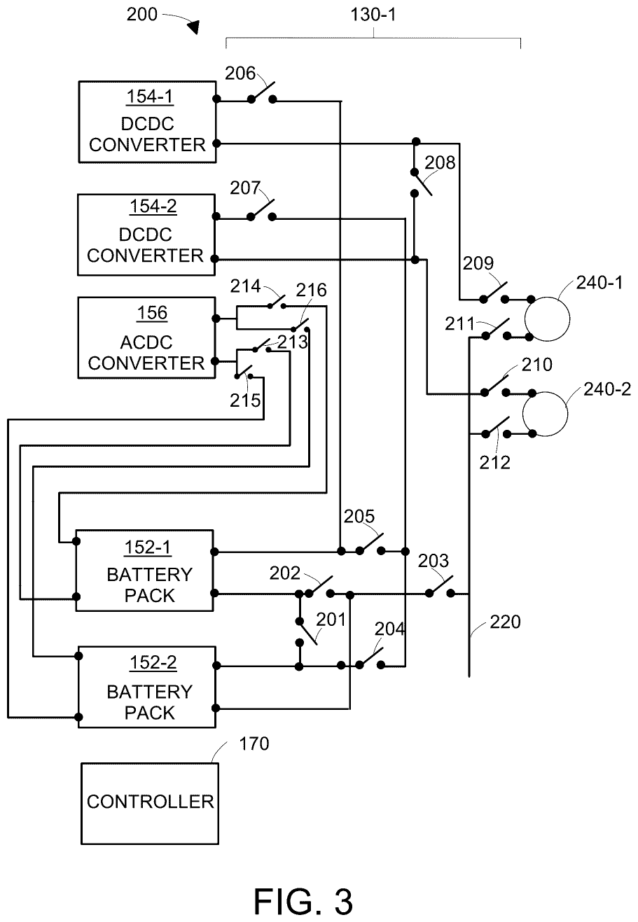

Reference is now made to FIG. 3 where there is shown a diagram of an electric vehicle charging station 200 according to one or more embodiments of the present invention. FIG. 3 shows system 200 comprising a first battery pack 152-1, a second battery pack 152-2, a first DCDC converter 154-1, a second DCDC converter 154-2, an ACDC converter 156, a controller 170, a network of wired contactors 130-1 that include contactor 201, contactor 202, contactor 203, contactor 204, contactor 205, contactor 206, contactor 207, contactor 208, contactor 209, contactor 210, contactor 211, contactor 212, contactor 213, contactor 214, contactor 215, and contactor 216. Charging station 200 is shown in FIG. 3 having a first charging port 240-1 and a second charging port 240-2 to accommodate charging one or two electric vehicles.

The network of wired contactors interconnect components of charging station 200 to allow electric power to be delivered to charging port 240-1 and charging port 240-2. The routing of the electric power through the components of system 200 is controlled by controller 170. Controller 170 is connected with first battery pack 152-1, second battery pack 152-2, first DCDC converter 154-1, second DCDC converter 154-2, ACDC converter 156, contactor 201, contactor 202, contactor 203, contactor 204, contactor 205, contactor 206, contactor 207, contactor 208, contactor 209, contactor 210, contactor 211, contactor 212, contactor 213, contactor 214, contactor 215, and contactor 216 to accomplish processes such as data collection, information transfer, and execution of commands. According to one or more embodiments of the present invention, controller 170 also connects with the electric vehicles at charging port 240-1 and/or charging port 240-2 (electric vehicles not shown in FIG. 3) such as for information transfer. As an option for one or more embodiments of the present invention, controller 170 may be connected with components of electric vehicle charging station 200 using communication systems such as, but not limited to, a Controller Area Network such as a CAN bus, an Ethernet, a Programmable Logic Controller, other system, and combinations thereof. Connections between controller 170 and other components of system 200 are not shown in order to maintain clarity in FIG. 3.

According to one or more embodiments of the present invention, battery pack 152-1 and battery pack 152-2 have capacities selected for electric vehicle charging. According to one embodiment of the present invention battery pack 152-1 is a 400 V battery pack and battery pack 152-2 is a 400 V battery pack. As an option the battery cells of battery pack 152-1 and battery pack 152-2 may be lithium ion battery cells or other types of battery cells.

ACDC converter 156 may be connected with an alternating current electric power source such as an electric grid to receive electric power that ACDC converter 156 converts to DC power. According to one or more embodiments of the present invention, ACDC converter 156 may be connected with an AC power grid that provides electric power such as that are used for Level 2 electric vehicle charging which may use United States standard voltages of about 208 V and 240 V or similar voltage standards. The network of wired contactors routes DC power from ACDC converter 156 to battery pack 152-1 and battery pack 152-2 to charge the battery cells. More specifically, contactors 213, 214, 215, and 216 under the control of controller 170 are used to direct DC power to charge battery pack 152-1 and battery pack 152-2 separately or together.

Controller 170 uses the network of wired contactors to route power from battery pack 152-1 and battery pack 152-2 to DCDC converter 154-1 and DCDC converter 154-2 where the voltage output from the batteries may be increased or decreased before the power is directed to charging port 240-1 and charging port 240-2 charging electric vehicles. According to one or more embodiments of the present invention controller 170 uses contactors 201 through 212 to provide two or more voltages for charging electric vehicles connected at charging port 240-1 and charging port 240-2. In other words, controller 170 selects on/off conditions for the contactors so as to interconnect the DC power sources to provide the two or more voltages for charging electric vehicles.

As an option for one or more embodiments of the present invention, electric vehicle charging station 200 can be operated to provide multiple voltage ranges for charging electric vehicles. The voltage ranges will depend on the specifications and capacities of the components of electric vehicle charging station 200. An example of specifications for electric vehicle charging station 200 according to one or more embodiments of the present invention includes the battery packs having capacities of 400 VDC; the ACDC converter having a range of 200-840 VDC, 10 KW×2, or 20 kW; the DCDC converters having a range of 100-1000 VDC, 75 kW capacity. An electric vehicle charging station 200 with those specifications provides the following options through selecting the on-off states of the contactors: first charging port 240-1 charging voltage range 200-500 VDC; first charging port 240-1 combo charging voltage range 200-500 VDC; second charging port 240-2 charging voltage range 200-500 VDC; second charging port 240-2 combo charging voltage range 200-500 VDC; first charging port 240-1 and second charging port 240-2 charging voltage range 200-500 VDC; first charging port 240-1 charging voltage 1000 VDC; second charging port 240-2 charging voltage 1000 VDC; and first charging port 240-1 and second charging port 240-2 charging voltage 1000 VDC.

Embodiments of electric vehicle charging system 200 can offer multiple options for charging battery pack 152-1 and battery pack 152-2. Through selection of on-off contactor states, battery pack 152-1 and battery pack 152-2 can be charged together as a single battery pack or as separate battery packs. As an example, they can be charged as an 800 V battery pack if battery pack 152-1 and battery pack 152-2 are 400 V battery packs or they can each be charged separately as 400 V battery packs.

Some details which may be routine and known to persons of ordinary skill in the art in view of the present disclosure have been left out of FIG. 3 for clarity. Examples of items not shown in but would be ordinary inclusions in such systems are protection fuses, output filters, sensors, and monitoring equipment. FIG. 3 shows part of high-voltage negative wire 220, but does not show high voltage negative wire 220 continuing on to make connection with DCDC converter 154-1 and DCDC converter 154-2.

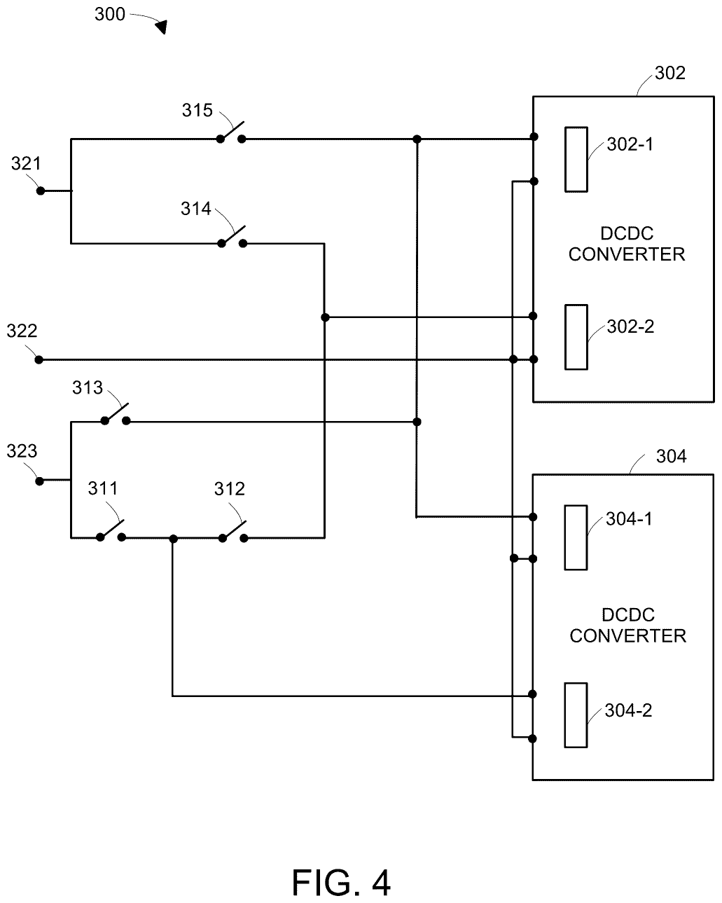

Reference is now made to FIG. 4 where there is shown a diagram for a DC module 300 according to one or more embodiments of the present invention. DC module 300 may be used as a DC power source for electric vehicle charging stations such as for embodiments of the present invention described in FIGS. 1, 1-2, 1-3, 1-5, 1-6, 2, 2-1, 2-2, and 3.

DC module 300 shown in FIG. 4 includes a DCDC reversible power converter 302 having a high-voltage side 302-1 and a low-voltage side 302-2 and a DCDC reversible power converter 304 having a high-voltage side 304-1 and a low-voltage side 304-2. DC module 300 also includes a DC module network of wired contactors including contactor 311, contactor 312, contactor 313, contactor 314, and contactor 315 that connect DCDC reversible power converter 302 and DCDC reversible power converter 304. By selecting the on-off states for contactor 311, contactor 312, contactor 313, contactor 314, and contactor 315, DC module 300 can be operated in a variety of modes. Examples of possible modes for operating DC module 300 include, but are not limited to, buck mode, boost mode, and boost buck mode. The on-off states for contactor 311, contactor 312, contactor 313, contactor 314, and contactor 315 may be controlled by a controller such as controller 170 as described above or a different controller. One embodiment of the present invention is an electric vehicle charging station that comprises a first DC module 300 and a second DC module 300 connected to provide electric power to charge an electric vehicle. One embodiment of the present invention is a charging process comprising operating the first DC module 300 and the second DC module 300 in buck mode, boost mode, and boost buck mode using the DC module network of wired contactors including contactor 311, contactor 312, contactor 313, contactor 314, and contactor 315 that connect DCDC reversible power converter 302 and DCDC reversible power converter 304 present in each DC module 300 as described for FIG. 4. More specifically, the charging process includes operating the first DC module 300 and the second DC module 300 in buck mode, boost mode, and boost buck mode to provide charging parameters that equal or approximate charging parameters requested by the electric vehicle.

According to one or more other embodiments of the present invention, DC module 300 shown in FIG. 4 may have DCDC reversible power converter 302 replaced with a DCDC bidirectional buck boost power converter and DCDC reversible power converter 304 replaced with a DCDC bidirectional buck boost power converter. DC module 300 also includes a DC module network of wired contactors including contactor 311, contactor 312, contactor 313, contactor 314, and contactor 315 that connect buck boost converter 302 and buck boost converter 304. By selecting the on-off states for contactor 311, contactor 312, contactor 313, contactor 314, and contactor 315, DC module 300 can be operated in a variety of modes. Examples of possible modes for operating DC module 300 include, but are not limited to, buck mode, boost mode, and boost buck mode. The on-off states for contactor 311, contactor 312, contactor 313, contactor 314, and contactor 315 may be controlled by a controller such as controller 170 as described above or a different controller.

According to one or more embodiments of the present invention electric vehicle charging stations such as those described above for FIGS. 1, 1-2, 1-3, 1-5, 1-6, 2, 2-1, 2-2, and 3 may include using two or more DC module 300 as part of the plurality of DC sources. Such embodiments of the present invention can allow use of dynamically changing charging parameters such as the charging voltage and/or the charging current in response to inputs such as, but not limited to, a charging protocol, charging parameter requests from an electric vehicle, charging parameter request from an electric vehicle as it is being charged, or combinations thereof. According to one or more embodiments of the present invention substantially seamless changes to the charging parameters can be accomplished essentially without interruption of the charging process. According to one or more embodiments of the present invention, the change in parameters provides no user or operator detectable interruption of the charging process. Furthermore, one or more embodiments of the present invention may enable more efficient use of electric vehicle charging stations when charging or having to charge multiple electric vehicles using DC fast charging.

Electric vehicle charging stations according to one or more embodiments of the present invention may use a variety of components, specifications, and design parameters as will be clear to persons of ordinary skill in the art in view of the present disclosure. One or more embodiments of the present invention may include components, specifications, and design parameters such as, but not limited to the following: Battery pack 152-1 and battery pack 152-2 may use lithium ion battery chemistry such as nickel manganese cobalt energy chemistries or lithium iron phosphate chemistries. For some embodiments of the present invention battery pack 152-1 and battery pack 152-2 are 400 V battery packs and may have an energy storage capacity of 160 kWh. According to one or more embodiments of the present invention, charge port 240-1 and charge port 240-2 may have an output of 150 KW for CCS charging, 100 KW for CHAdeMO charging, 75 KW each when charging two electric vehicles simultaneously. According to one or more embodiments of the present invention, electric vehicle charging station may have an output current of 300 A for CCS charging and 200 A for CHAdeMO charging. Electric vehicle charging stations according to one or more embodiments of the present invention, use an input power of less than or equal to 27 kW AC power.

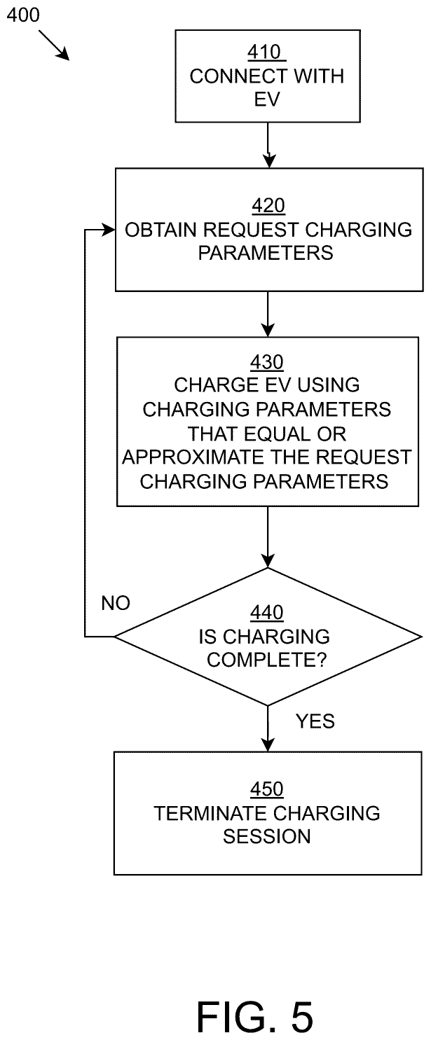

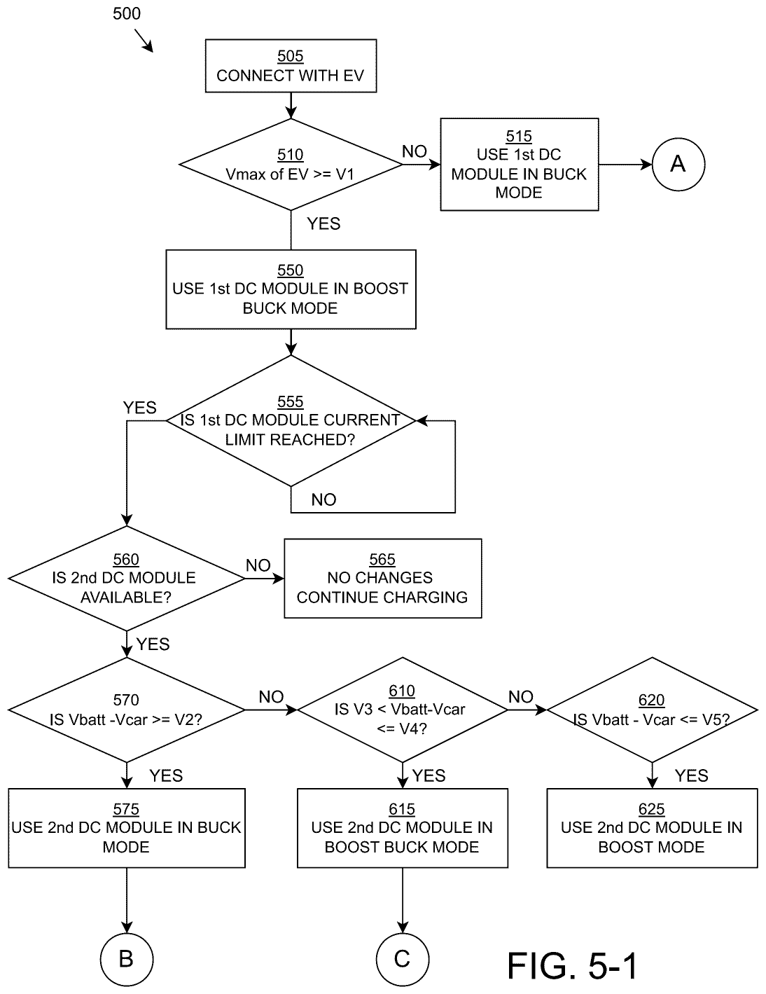

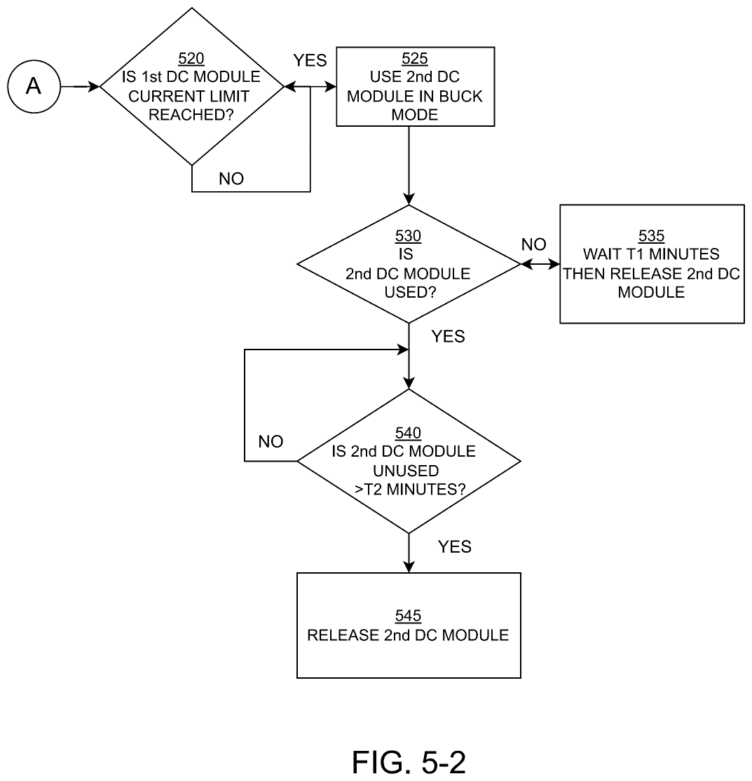

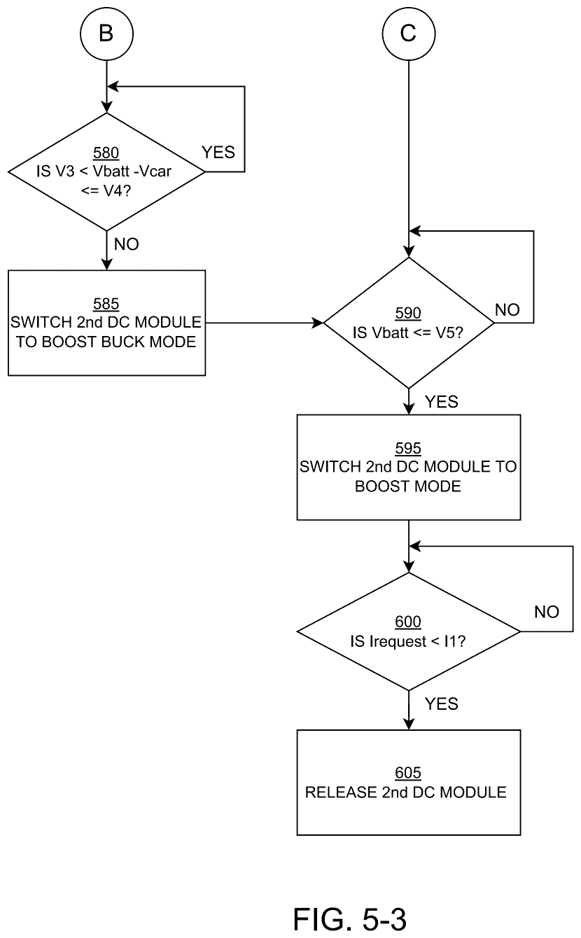

Reference is now made to FIG. 5 where there is shown a process flow 400 according to one or more embodiments of the present invention. One embodiment of the present invention comprises a method of charging one or more electric vehicles. The method is performed using an electric vehicle charging station that includes a plurality of DCDC converters interconnected with a power source accomplished with wiring and a network of contactors to control power received and power output by the plurality of DCDC converters, and a controller in communication with the network of contactors. In other words, the method comprises using embodiments of the present invention described for FIGS. 1, 1-2, 1-3, 1-5, 1-6, 2, 2-1, 2-2, and 3 to execute process flow 400. Process flow 400 includes process 410, process 420, process 430, process 440, and process 450.

Process 410 may be the start of a process flow 400. Process 410 involves, but is not limited to, connecting an electric vehicle to an electric vehicle charging station according to one or more embodiments of the present invention. The connection includes joining the electric vehicle charging connector to the electric vehicle so as to at least allow power transfer to conductively charge the electric vehicle. Process 410 may also include establishing an information transfer connection between the electric vehicle charging station and the electric vehicle. According to one or more embodiments of the present invention, the controller for the electric vehicle charging station may send and receive information to the electric vehicle such as to a controller for the electric vehicle or such as to a battery management system for the electric vehicle. Optionally, the information transfer between the electric vehicle charging station and the electric vehicle may be accomplished through a hardwired connection such as using wiring included with the electric vehicle charging connector and charger cable. Alternatively, a wireless information transfer connection may be established between the electric vehicle charging station and the electric vehicle for information transfer.

Process 420 follows process 410. Process 410 involves, but is not limited to, obtaining requested charging parameters for charging the electric vehicle. According to one embodiment of the present invention, the requested charging parameters may be derived by or selected by a user or operator of the electric vehicle charging system. According to another embodiment of the present invention, the requested charging parameters may be obtained from a charging protocol that may be predetermined. According to another embodiment of the present invention the requested charging parameters may be obtained from the electric vehicle such as from the battery management system for the electric vehicle.

Process 430 follows process 420. Process 430 involves, but is not limited to, charging the electric vehicle using charging parameters that equal or approximate the requested charging parameters. Process 430 may include having the controller for the electric vehicle charging station reconfigure the interconnections between the DC power sources of the electric vehicle charging station via changing the on-off states for the contactors to produce circuit connections needed so as to provide charging parameters that equal or approximate the requested charging parameters. The on-off states for the contactors used by the controller may be derived from a lookup table of contactor states that provide charging parameters that equal or approximate the requested charging parameters.

According to one embodiment of the present invention, process 430 may include having the electric vehicle charging station enter a back-and-forth communication with the electric vehicle such as to make known the available charging parameters such as available charging voltage and/or available charging current and seeking responses to whether the available charging parameters are acceptable for charging the electric vehicle. As an example, the electric vehicle charging station or the controller for the electric vehicle charging station may advertise the available current for charging the electric vehicle for approval to charge the electric vehicle.

Process 430 may further include charging the electric vehicle using charging parameters that equal or approximate the requested charging parameters to accomplish an amount of charging for the electric vehicle. The amount of charging may vary. In some instances, the amount of charge is full charge for the electric vehicle battery. In other instances, the amount of charging may be less than full charge such as an amount of charge selected by a user or an operator of the electric vehicle charging station. In other instances, the amount of charging may depend on the amount of time available for charging the electric vehicle.

Process 440 follows process 430. Process 440 is a decision process which either returns to process 420 if the electric vehicle charging is not complete or proceeds to process 450 if the electric vehicle charging is complete. For some embodiments of the present invention, process 440 may include having the controller for the electric vehicle charging system periodically check to see if charging is complete. Checking whether charging is complete may include actions such as determining whether an end to the charging has been initiated by one or more of the following: by a user of the electric vehicle, by an operator of the electric vehicle charging station, an end for the charging time interval, a command from the electric vehicle, a requested amount of charging has been achieved, or combinations thereof. According to one or more embodiments of the present invention, if the charging is not complete then the electric vehicle charging station controller may obtain requested charging parameters and update the charging parameters being used if the requested charging parameters have changed.

Process 450 involves, but is not limited to, terminating the charging session includes shutting off or redirecting power being used for charging the electric vehicle. For some embodiments of the present invention, process 450 may also include alerting the user or the operator of the electric vehicle charging station that the charging is complete.

Reference is now made to FIG. 5-1, FIG. 5-2, and FIG. 5-3 where there is shown process flow 500 for charging one or more electric vehicles according to one embodiment of the present invention. Process flow 500 is shown spread over FIG. 5-1, FIG. 5-2, and FIG. 5-3. More specifically, process flow 500 is shown in part in FIG. 5-1 with designated connections points as circled A, circled B, and circled C. Connection point circled A on FIG. 5-1 corresponds to connection point circled A on FIG. 5-2 for joining FIG. 5-1 and FIG. 5-2. Connection point circled B and connection point circled C on FIG. 5-1 correspond to connection point circled B and connection point circled C on FIG. 5-3 for joining FIG. 5-1 and FIG. 5-3.

Process flow 500 is performed using an electric vehicle charging station that includes a plurality of bidirectional DCDC buck boost converters or a plurality of DCDC reversible power converters interconnected with a power source accomplished with wiring and a network of contactors to control power received and power output by the plurality of bidirectional DCDC buck boost converters, and a controller in communication with the network of contactors. Process flow 500 may be performed using electric vehicle charging stations such as those described for FIGS. 1, 1-2, 1-3, 1-5, 1-6, 2, 2-1, 2-2, 3, and 4. More specifically, process flow 500 is performed using an electric vehicle charging station that includes two DC modules such as DC module 300 described above and in FIG. 4 as DC sources in the electric vehicle charging stations; which are identified as 1st DC Module and 2nd DC Module in process flow 500. FIG. 5-1, FIG. 5-2, and FIG. 5-3 show process flow 500 including processes 505, 510, 515, 520, 525, 530, 535, 540, 545, 550, 555, 560, 565, 570, 575, 580, 585, 590, 595, 600, 605, 610, 615, 620, and 625.

Process 505 may be the start of a process flow 500. Process 505 involves, but is not limited to, connecting an electric vehicle to an electric vehicle charging station according to one or more embodiments of the present invention. The connection includes joining the electric vehicle charging station connector to the electric vehicle so as to at least allow power transfer to conductively charge the electric vehicle. Process 505 may also include establishing an information transfer connection between the electric vehicle charging station and the electric vehicle. According to one or more embodiments of the present invention, the controller for the electric vehicle charging station may send and receive information to the electric vehicle such as to a controller for the electric vehicle or such as to a battery management system for the electric vehicle. Optionally, the information transfer between the electric vehicle charging station and electric vehicle may be accomplished through a hardwired connection such as using wiring included with the electric vehicle charging connector and charger cable. Alternatively, a wireless information transfer connection may be established between the electric vehicle charging station and the electric vehicle for information transfer.

Process 505 may also involve obtaining requested charging parameters for charging the electric vehicle. According to one embodiment of the present invention, the requested charging parameters are obtained from the electric vehicle such as from the battery management system for the electric vehicle or other controller for the electric vehicle. Information obtained from the electric vehicle by the controller for the electric vehicle charging station includes parameters such as the maximum voltage (Vmax) of the electric vehicle.

Process 510 follows process 505. Process 510 is a decision process which either transfers to process 515 if the electric vehicle charging Vmax is not greater than or equal to V1 or proceeds to process 550 if the electric vehicle charging Vmax is greater than or equal to V1. For some embodiments of the present invention, V1 may be, but is not limited to, a voltage of about 500 V.

Process 515 involves, but is not limited to, using the 1st DC Module in buck mode to charge the electric vehicle using charging parameters approximate or equal charging parameters requested by the electric vehicle. Process 520 follows process 515. Process 520 is a decision process which involves, but is not limited to, either transfer to process 525 if the 1st DC Module current limit is reached charging the electric vehicle. Process 520 loops back to itself if the 1st DC Module current limit is not reached charging the electric vehicle.

Process 525 involves, but is not limited to, also using the 2nd DC Module in buck mode to charge the electric vehicle. Process 525 is followed by process 530. Process 530 is a decision process that involves, but is not limited to, determining if the 2nd DC Module is being used. If the 2nd DC Module is not being used, then process 530 transfers to process 535. Process 535 may include, but is not limited to, waiting T1 minutes then releasing the 2nd DC Module from charging the electric vehicle. T1 is a period of time selected as an operating parameter for the electric vehicle charging station. According to one embodiment of the present invention, T1 may equal, but is not limited to, 5 minutes. If process 530 shows 2nd DC Module as being used, then process 530 transfers to process 540.

Process 540 is a decision process that transfers to process 545 if the 2nd DC Module is unused for greater than T2 minutes. If the 2nd DC Module is not unused for greater than T2 minutes then process 540 loops back to itself. According to one embodiment of the present invention, T2 may equal, but is not limited to, 2 minutes. Process 545 involves, but is not limited to, releasing the 2nd DC Module from charging the electric vehicle.

Process 550 involves, but not limited to, using the 1st DC Module in boost buck mode to charge the electric vehicle. According to one embodiment of the present invention, process 550 may include having the electric vehicle charging station enter a back-and-forth communication with the electric vehicle such as to make known the available charging parameters such as available charging voltage and/or available charging current and seeking responses to whether the available charging parameters are acceptable for charging the electric vehicle. As an example, the electric vehicle charging station or the controller for the electric vehicle charging station may advertise the available current for charging the electric vehicle for approval to charge the electric vehicle.

Process 555 is a decision process which involves, but is not limited to, either transfer to process 560 if the 1st DC Module current limit is reached charging the electric vehicle. Process 550 loops back to itself the 1st DC Module current limit is not reached charging the electric vehicle.

Process 560 is a decision process that involves, but is not limited to, determining if the 2nd DC Module is available for use to charge the electric vehicle. If the 2nd DC Module is not available, then process 560 transfers to process 565. Process 565 involves, but is not limited to maintaining the charging conditions without changes. According to one or more embodiments of the present invention, process 565 may loop back to process 560 to check for the availability of the 2nd DC Module. Decision process 560 transfers to process 570 if the 2nd DC Module is available for charging the electric vehicle.

Process 570 is a decision process that involves, but is not limited to, determining if Vbatt−Vcar>=V2 for which Vbatt is the voltage for the charging station batteries such as for battery packs 152-1 and 152-2 in FIG. 3, and Vcar is the voltage for the car battery that is being charged. For some embodiments of the present invention, V2 may be, but is not limited to, a voltage of about 50 V. If Vbatt−Vcar>=V2 is true, then process 570 transfers to process 575. Process 575 involves, but is not limited to, also using the 2nd DC Module in buck mode to charge the electric vehicle. If Vbatt−Vcar>=V2 is false, then process 570 transfers to process 610.

Process 610 is a decision process that involves, but is not limited to, determining if V3<Vbatt−Vcar<=V4. For some embodiments of the present invention, V3 may be, but is not limited to, a voltage of about −49 V and V4 may be, but is not limited to, a voltage of about 49 V. If V3<Vbatt−Vcar<=V4 is true, then process 610 transfers to process 615. If V3<Vbatt−Vcar<=V4 is false, then process 610 transfers to process 620. Process 615 involves, but is not limited to, also using the 2nd DC Module in boost buck mode to charge the electric vehicle.

Process 620 is a decision process that involves, but is not limited to, determining if Vbatt−Vcar<=V5. For some embodiments of the present invention, V5 may be, but is not limited to, a voltage of about −50 V. If Vbatt−Vcar<=V5 is true, then process 620 transfers to process 625. Process 625 involves, but is not limited to, also using the 2nd DC Module in boost mode to charge the electric vehicle. If Vbatt−Vcar<=V5 is false, then process 620 is followed by a process of also using the 2nd DC Module in boost buck mode to charge the electric vehicle; according to one embodiment of the present invention this can be a transfer to process 615 (transfer to process 615 from process 620 not shown in FIG. 5-1).

Process 580 follows process 575. Process 580 is a decision process that involves, but is not limited to, determining if V3<Vbatt−Vcar<=V4. For some embodiments of the present invention, V3 may be, but is not limited to, a voltage of about −49 V, and V4 may be, but is not limited to, a voltage of about 49 V. If V3<Vbatt−Vcar<=V4 is true, then process 580 loops back to itself. If V3<Vbatt−Vcar<=V4 is false, then process 580 transfers to process 585. Process 585 involves, but is not limited to, switching the 2nd DC Module to boost buck mode to charge the electric vehicle.

Process 590 follows process 585 and process 615. Process 590 is a decision process that involves, but is not limited to, determining if Vbatt<=V5. For some embodiments of the present invention, V5 may be, but is not limited to, a voltage of about −50 V. If Vbatt<=V5 is false, then process 590 loops back to itself. If Vbatt<=V5 is true, then process 590 transfers to process 595. Process 595 involves, but is not limited to, switching the 2nd DC Module to boost mode to charge the electric vehicle.

Process 600 follows process 595. Process 600 is a decision process that involves, but is not limited to, determining if Irequest<I1; Irequest is a request current for charging the electric vehicle. For some embodiments of the present invention, I1 may be, but is not limited to, a current of about 95 amperes. If Irequest<I1 is false, then process 600 loops back to itself. If Irequest<I1 is true, then process 600 transfers to process 605. Process 605 involves, but is not limited to, releasing the 2nd DC Module from charging the electric vehicle.

One embodiment of the present invention comprises a method of charging one or more electric vehicles. The method is performed using an electric vehicle charging station that includes a plurality of bidirectional DCDC buck boost converters interconnected with a power source accomplished with wiring and a network of contactors to control power received and power output by the plurality of bidirectional DCDC buck boost converters, and a controller in communication with the network of contactors. The method comprises processes: A. connecting the controller with the one or more electric vehicles to receive information; B. connecting the one or more electric vehicles to transfer electric power to the one or more electric vehicles; C. using the controller to obtain requested charging voltage and/or charging current from the one or more electric vehicles; D. modifying the circuit connections for the plurality of bidirectional DCDC buck boost converters with the controller activating opening and closing contactors in the network of contactors to provide at least an approximation of the requested charging voltage and/or current to charge the one or more electric vehicles; E. repeating C and D without interrupting the charging to accomplish an amount of charge for the one or more electric vehicles; and F. terminating the connections with the one or more electric vehicles.

One embodiment of the present invention comprises a method of charging one or more electric vehicles. The method is performed using an electric vehicle charging station that includes a plurality of DCDC reversable power converters interconnected with a power source accomplished with wiring and a network of contactors to control power received and power output by the plurality of a plurality of DCDC reversable power converters, and a controller in communication with the network of contactors. The method comprises processes: A. connecting the controller with the one or more electric vehicles to receive information; B. connecting the one or more electric vehicles to transfer electric power to the one or more electric vehicles; C. using the controller to obtain requested charging voltage and/or charging current from the one or more electric vehicles; D. modifying the circuit connections for the plurality of a plurality of DCDC reversable power converters with the controller activating opening and closing contactors in the network of contactors to provide at least an approximation of the requested charging voltage and/or current to charge the one or more electric vehicles; E. repeating C and D without interrupting the charging to accomplish an amount of charge for the one or more electric vehicles; and F. terminating the connections with the one or more electric vehicles.

As an option for embodiments of the present invention, the amount of charge for process E is full charge. As an option for embodiments of the present invention, the amount of charge for process E is a request from the one or more electric vehicles. As an option for one or more embodiments of the present invention, the amount of charge for process E can be user specified.

As an option for embodiments of the present invention, the plurality of DCDC power converters comprises a first DCDC reversible power converter and a second DCDC reversible power converter, and process D comprises at least one of: operating the first DCDC reversible power converter to step up voltage or to step down voltage for the input power; operating the second DCDC reversible power converter to step up voltage or to step down voltage for the input power; operating the first DCDC reversible power converter to step up voltage while operating the second DCDC reversable power convert to step down voltage for the input power; operating the first DCDC reversible power converter to step up voltage while operating the second DCDC reversable power converter to step up voltage for the input power; operating the first DCDC reversible power converter to step down voltage while operating the second DCDC reversable power convert to step down voltage for the input power; and operating the first DCDC reversible power converter to step down voltage while operating the second DCDC reversable power convert to step up voltage for the input power.

As an option for embodiments of the present invention, the plurality of DCDC reversable power converters comprises a first DCDC reversible power converter and a second DCDC reversible power converter, and process D comprises at least one of: operating the first DCDC reversible power converter in buck mode while operating the second DCDC reversible power converter in buck mode; operating the first DCDC reversible power converter in boost buck mode while operating the second bidirectional DCDC buck boost converter in buck mode; operating the first bidirectional DCDC buck boost converter in boost buck mode while operating the second bidirectional DCDC buck boost converter in boost buck mode; operating the first bidirectional DCDC buck boost converter in boost buck mode while operating the second bidirectional DCDC buck boost converter in boost mode; operating the first bidirectional DCDC buck boost converter in boost mode while operating the second bidirectional DCDC buck boost converter in buck mode; and operating the first bidirectional DCDC buck boost converter in boost mode while operating the second bidirectional DCDC buck boost converter in boost mode.

As an option for embodiments of the present invention, the plurality of bidirectional DCDC power converters comprises a first bidirectional DCDC buck boost converter and a second bidirectional DCDC buck boost converter, and process D comprises at least one of: if Vmax of the electric vehicle is not greater than or equal to 500V, then operating the first bidirectional DCDC buck boost converter in buck mode; if Vmax of the electric vehicle is not greater than or equal to 500V, then operating the first bidirectional DCDC buck boost converter in buck mode and if the current limit is reached for the first bidirectional DCDC buck boost converter, then also operating the second bidirectional DCDC buck boost converter in buck mode; if Vmax of the electric vehicle is greater than or equal to 500V, then operating the first bidirectional DCDC buck boost converter in boost buck mode; if Vmax of the electric vehicle is greater than or equal to 500V, then operating the first bidirectional DCDC buck boost converter in boost buck mode and if the current limit is reached for the first bidirectional DCDC buck boost converter, then also operating the second bidirectional DCDC buck boost converter: in buck mode if Vbatt-Vcar>=50V; in boost buck mode if −49<Vbatt-Vcar<=49V; and in boost mode if Vbatt−Vcar<=−50V.

Another embodiment of the present invention is a method comprising: automatically changing the charging parameters being used by an electric vehicle charging station to charge the electric vehicle in response to requested charging parameters from the electric vehicle so that the charging of the electric vehicle is substantially uninterrupted by changes in the charging parameters. As an option for embodiments of the present invention, the electric vehicle charging station comprises: a first DC module comprising a first DCDC bidirectional power converter, a second DCDC bidirectional power converter, and a first module network of wired contactors to operate the first DC module in buck mode, boost mode, or boost buck mode; and a second DC module comprising a third DCDC bidirectional power converter, a fourth DCDC bidirectional power converter, and a second module network of wired contactors to operate the second DCDC module in buck mode, boost mode, or boost buck mode.

Embodiments of the present invention may further comprise at least one of: if Vmax of the electric vehicle is not greater than or equal to V1, then operating the first bidirectional DCDC buck boost converter in buck mode; if Vmax of the electric vehicle is not greater than or equal to V1, then operating the first bidirectional DCDC buck boost converter in buck mode and if the current limit is reached for the first bidirectional DCDC buck boost converter, then also operating the second bidirectional DCDC buck boost converter in buck mode; if Vmax of the electric vehicle is greater than or equal to V1, then operating the first bidirectional DCDC buck boost converter in boost buck mode; if Vmax of the electric vehicle is greater than or equal to V1, then operating the first bidirectional DCDC buck boost converter in boost buck mode and if the current limit is reached for the first bidirectional DCDC buck boost converter, then also operating the second bidirectional DCDC buck boost converter: in buck mode if Vbatt-Vcar>=V2; in boost buck mode if V3<Vbatt-Vcar<=V4; and in boost mode if Vbatt−Vcar<=V5, wherein V1, V2, V3, V4, AND V5 are predetermined voltages.

Embodiments of the present invention may comprise at least one of: if Vmax of the electric vehicle is not greater than or equal to 500V, then operating the first DC module in buck mode; if Vmax of the electric vehicle is not greater than or equal to 500V, then operating the first DC module in buck mode and if the current limit is reached for the first DC module, then also operating the second DC module in buck mode; if Vmax of the electric vehicle is greater than or equal to 500V, then operating the first DC module in boost buck mode; if Vmax of the electric vehicle is greater than or equal to 500V, then operating the first DC module in boost buck mode and if the current limit for the first DC module is reached, then also use the second DC module in buck mode if Vbatt−Vcar=50V; if Vmax of the electric vehicle is greater than or equal to 500V, then operating the first DC module in boost buck mode and if the current limit for the first DC module is reached, then also use the second DC module in boost buck mode if −49V<Vbatt−Vcar<=49V; and if Vmax of the electric vehicle is greater than or equal to 500V, then operating the first DC module in boost buck mode and if the current limit for the first DC module is reached, then also use the second DC module in boost mode if Vbatt−Vcar<=−50V.

### Holster Embodiments

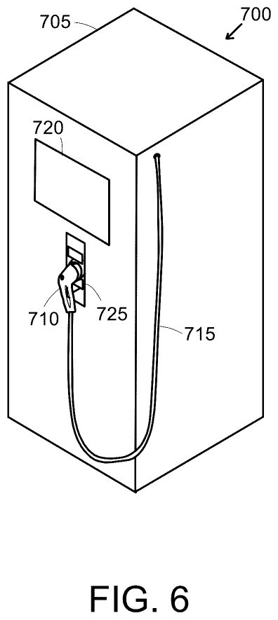

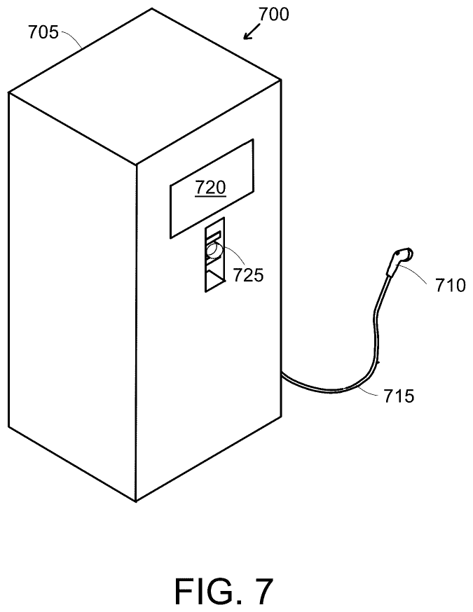

Reference is now made to FIGS. 6 through 14. FIG. 6 and FIG. 7 are perspective views of examples of an electric vehicle charging station 700. More Specifically, FIG. 6 illustrates an electric vehicle charging station 700 having an electric conduction power coupler comprising a charger connector 710 attached to a charger cable 715 for connection to an electric vehicle for charging the drive battery of the electric vehicle. For the embodiment illustrated in FIG. 6, the charging station includes a main housing 705; the main housing 705, while preferred, may be optional. Also shown for the embodiment in FIG. 6 is a user interface 720 which is also an option. The electric vehicle charging station 700 comprises a substantially vertically mounted holster 725 for storing charger connector 710.

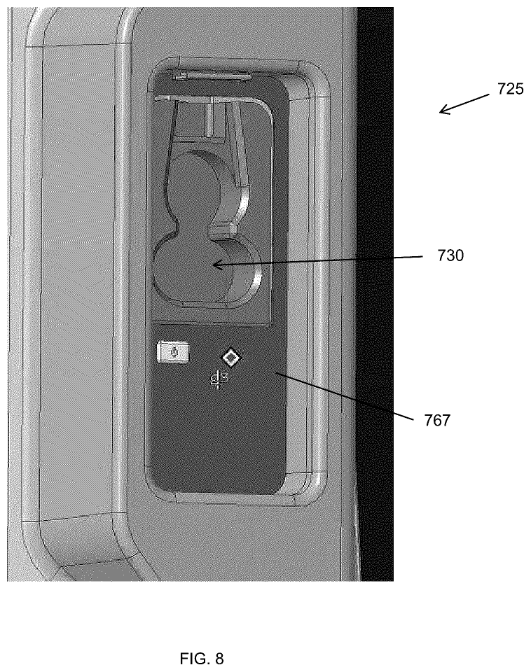

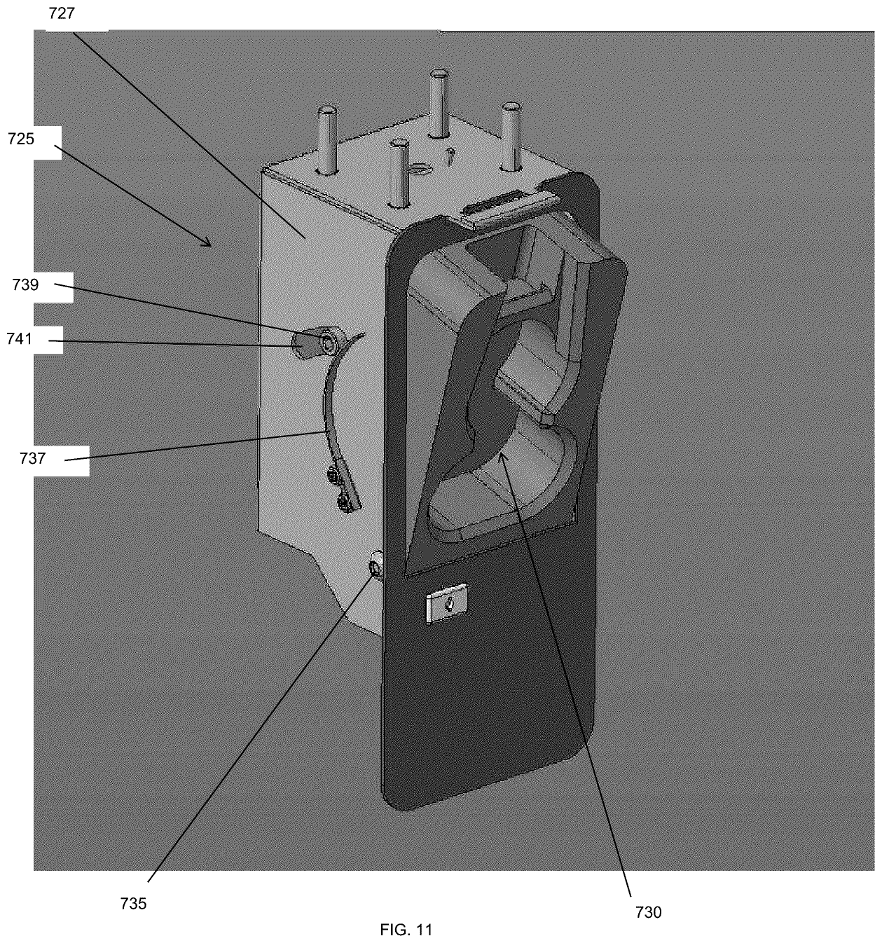

FIGS. 8-14 illustrate more detailed views of the holster 725. The holster 725 includes a substantially rigid base 727, a socket 730 to receive the electric power coupler 710, and a loaded hinge 735 connecting socket 730 to base 727 so as to rotatably urge, or bias, socket 730 using a first force into an up or stowed position for receiving the power coupler 710, the first force being less than a second force. The second force being a force produced by the weight of the power coupler when charger connector 710 in socket 730. The socket 730 is held in a tilted down or engaged position by the second force. The tilted down or engaged position is illustrated in FIG. 11 (the electric power coupler 710 is not shown in FIG. 11 for simplicity). The socket 730 is in the up or stowed position when the electric power coupler 710 is not in the socket as shown in FIGS. 8-10 and 12-14.

According to one or more embodiments of the present invention, the loaded hinge 735 includes a hinge coupled to a mechanism that generates a force such as, but not limited to, the following example embodiments. According to one or more embodiments of the present invention, the loaded hinge 735 includes a leaf spring 737. The leaf spring 737 is operatively coupled to a guide nut 739 that is located at least partially within a guide slot 741 that is formed in the substantially rigid base 727. The guide nut 739 is operatively connected to the socket 730 and the socket 730 is slidably or pivotably disposed within the substantially rigid base 727.

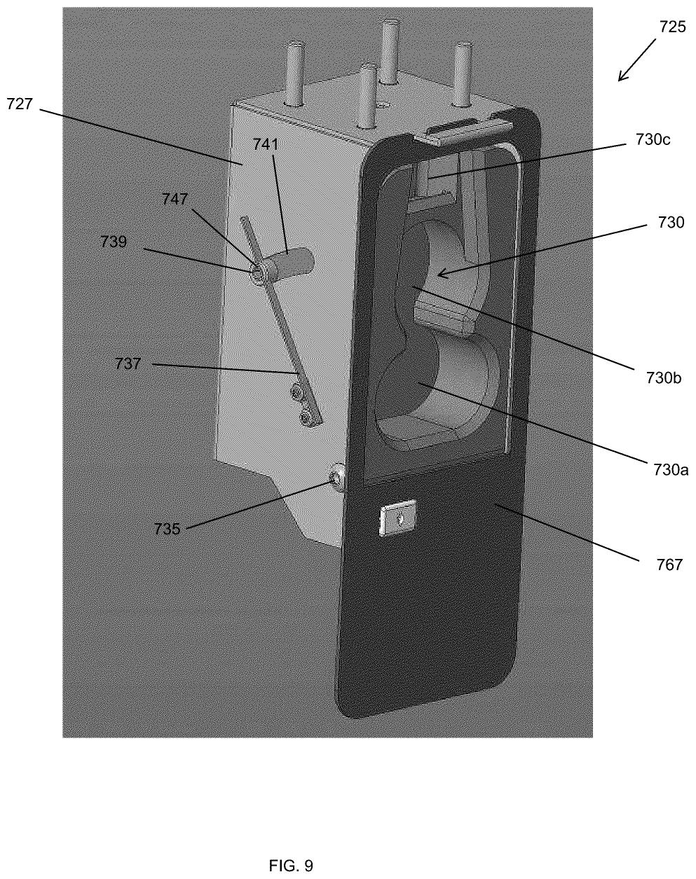

In the first (up or stowed) position (FIG. 9) when the electric power coupler 710 is not disposed in the socket 730, the leaf spring 737 forces the guide nut 739 towards a back of the guide slot 741, which is towards the back of the substantially rigid base 727. The guide slot 741 may be curved and the curvature may include a radius having its center located at the loaded hinge 735. When the electric power coupler 710 is disposed in the socket 730, the weight of the electric power coupler 710 creates a moment (which is the second force) about the loaded hinge 735 that overcomes the spring force generated by the leaf spring 737 (which is the first force), which causes the socket 730 to rotate outward, away from the back of the substantially rigid base 727 about the loaded hinge 735, as illustrated in FIG. 11.

This rotational movement (due to the second force) bends the leaf spring 737, which stores energy in the leaf spring 737 through deformation of the leaf spring 737. When the electric power coupler 710 is removed from the socket 737, the rotational moment caused by the weight of the electric power coupler 710 is also removed and the stored energy in the leaf spring 737 causes the guide nut 739 to slide towards the back of the substantially rigid base 727, which causes the socket 730 to rotate within the substantially rigid base 727 about the loaded hinge 735 and into to the up or stowed position illustrated in FIGS. 8 and 9.

The leaf spring 737 may be located between the guide slot 741 and the loaded hinge 735. In other embodiments, the leaf spring 737 may be located above the guide slot 741, such that the guide slot 741 disposed between at least a portion of the leaf spring 737 and the loaded hinge 735.

A portion of the leaf spring 737 may be disposed in a nut slot 747 in the guide nut 739 so that the leaf spring 737 may slide within the nut slot 747 as the socket 730 pivots about the loaded hinge 735. In other embodiments, the leaf spring 737 may rest against the guide nut 739 and the guide nut 739 may bend the leaf spring 737 as the socket 730 pivots towards the second position, as illustrated in FIG. 11.

In some embodiments, the socket 730 may comprise a first or upper lobe 730a and a second or lower lobe 730b. In other embodiments, the shape of the socket 730 may mirror the shape of a periphery of the electric power coupler 710.

The socket 730 may also include a locking ledge 730c that is configured to receive a locking lever on the electric power coupler 710 (not shown) that releasably locks the electric power coupler 710 within the socket 730 while the electric power coupler 710 is electrically connected to the socket 730 and the socket 730 is in the second (engaged) position. In some embodiments, the locking ledge 730c may include an upturned lip 751. In some embodiments, the locking ledge 730c may be located distal to the loaded hinge 735.

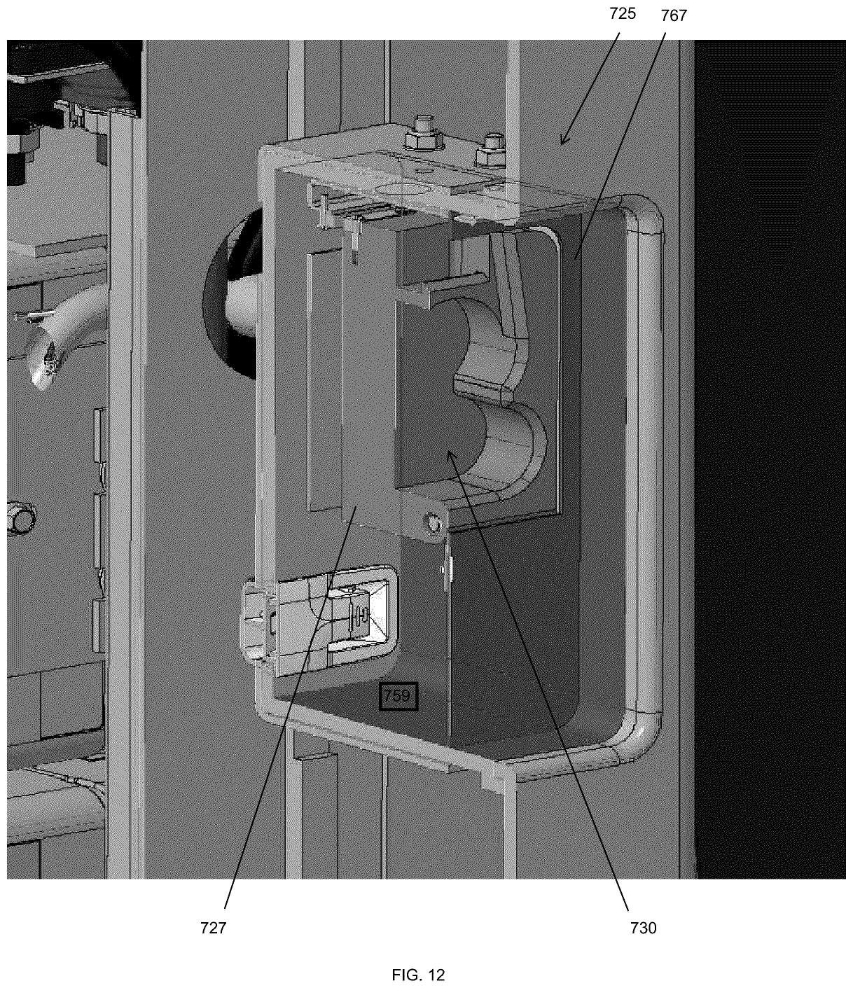

In some embodiments, portions of the socket 730 may be translucent or transparent so that a light source 759 (FIG. 12), such as an LED or incandescent bulb, may illuminate or back-light the holster 725 so that the socket 730 may be more easily located, especially in low light conditions. The light may extinguish or illuminate based on whether the electric charger connector 710 is attached to the holster 725 or not. In other embodiments, the light source 759 may illuminate one color (such as red in FIG. 11) when the holster 725 is not connected to electric charger connector 710 and the illumination of the light source 759 may change to a different color (such as green) when the electric charger connector 710 is connected to the holster 725. A faceplate 767 may be designed to block or mask certain areas of the socket 730 so that only desired portions of the socket 730 are illuminated when the light source is activated.

The holster 725 having the leaf spring 737 advantageously produces a simplified assembly that is more efficient to assemble and includes fewer parts. The leaf spring 737 is also more reliable than other types of rotational force mechanisms. The holster 725 is more robust, more wear resistant, and easier to service and replace than previous holsters. A holster 725 of this configuration is also employable as a modular component of a charging station, so as to lend to forward-compatibility, in that the holster 725 has few components and is mountable in a manner such that it can be easily replaced, such as in the event of worn components or in the event technological evolution of standards for charging plugs for use with electric vehicles dictates a need for a holster having a different configuration.

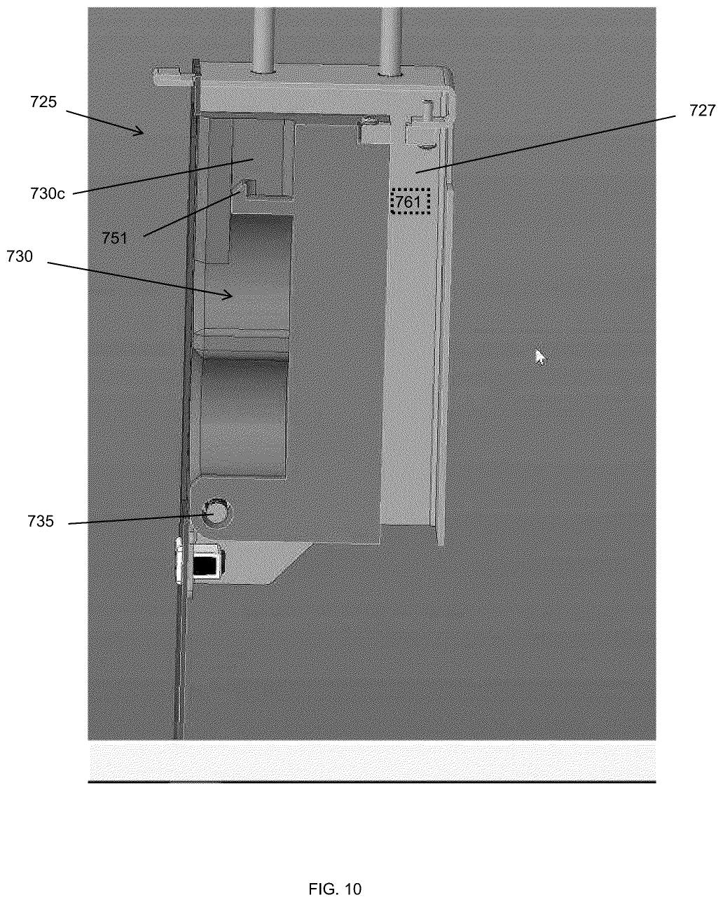

According to one or more embodiments of the present invention, electric vehicle charging station 700 further includes a sensor 761 (schematically illustrated in FIG. 10) providing a signal communicating whether charger connector 710 is in or out of socket 730 by determining if socket 730 is in the up (retracted) position or the tilted down (engaged) position. According to one or more embodiments of the present invention, sensor comprises a contact sensor, a pressure sensor, motion sensor, a magnetic field sensor, or combinations thereof. In the various embodiments, such a sensor is disposed at or near the top of the top of the holster 725, such that the sensor detects the position of the socket 730 when the socket is in a fully or nearly fully up (retracted) position. For example, a Hall effect sensor may be advantageously used in some embodiments to reliably detect the position of the socket 730 without the introduction of additional moving parts, thus reducing the likelihood of component failure.

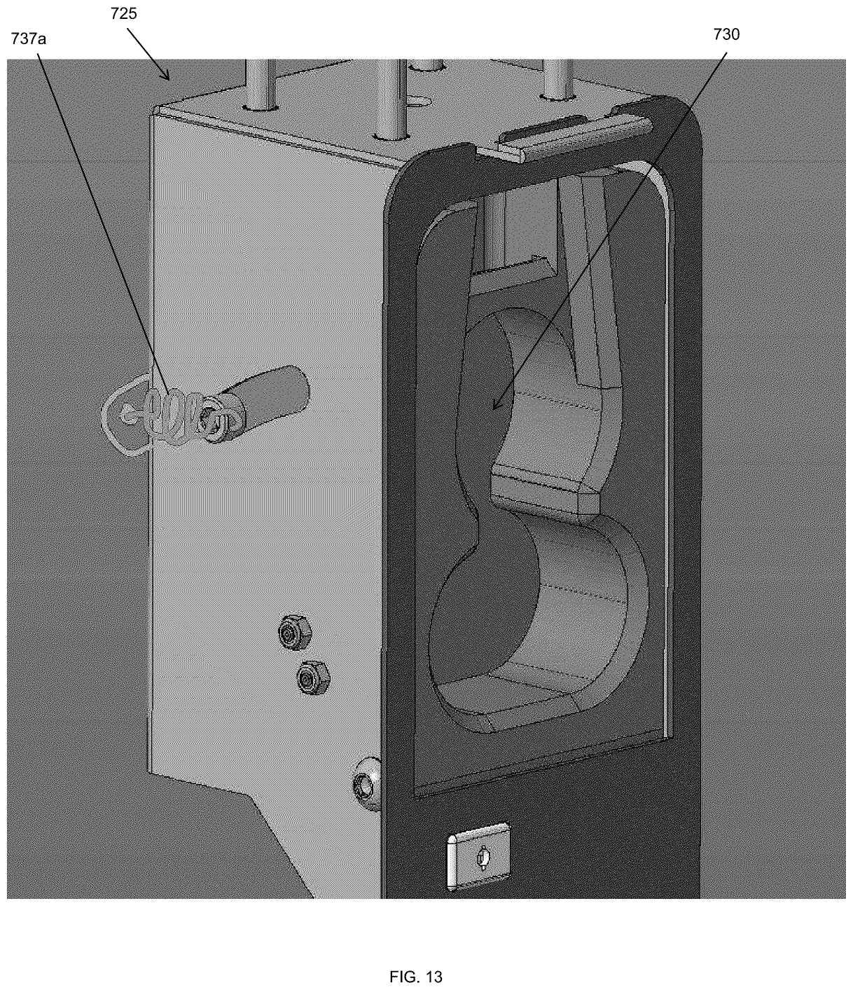

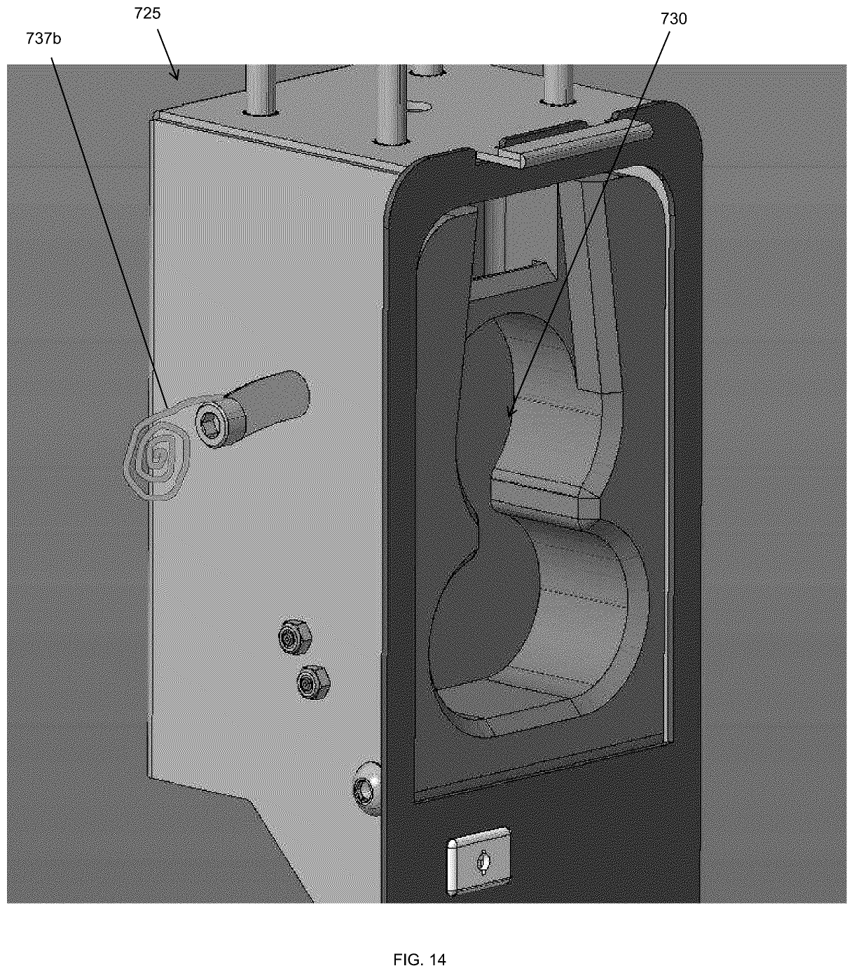

In other embodiments, other types of springs may be used. Such as a tension/compression spring 737a of, for example, a toroidal configuration (FIG. 13) or a constant force spring 737b of, for example, a coil configuration (FIG. 14).

According to one or more embodiments of the present invention, electric vehicle charging station 700 further comprises a controller (170 in FIG. 2) responsive to the sensor and a graphical user interface 720 connected with the controller to display information. According to one or more embodiments of the present invention, the controller is disposed in the main housing 705. According to one or more embodiments of the present invention, the controller comprises executable code to display a message on user interface 720 indicating whether charger connector 710 is in holster 725.

According to one or more embodiments of the present invention, the controller comprises executable code to transmit a message indicating the charger connector 710 is not in holster 725 if the charger connector has not been returned to the holster after a predetermined time interval.

According to one or more embodiments of the present invention, charger connector 710 comprises any electric vehicle charger connector. According to one or more embodiments of the present invention, charger connector 710 comprises a J1772 connector, CCS connector, or ChaDeMo connector.

Embodiments of the present invention are not limited to electric vehicle charging stations. More specifically, holsters such as those described above are not limited for use to only charger connectors such as those for electric vehicle charging. These holsters can be used for applications that have a nozzle connected with a hose for distributing fluids such as liquid phase fuel and/or gas phase fuel.

Electric vehicle charging stations such as, but not limited to those described above for FIGS. 1, 1-2, 1-3, 1-5, 1-6, 2, 2-1, 2-2, and 3 may further include a holster 725 substantially as described above.

As indicated above, one or more embodiments of the present invention may be used for applications other than charging electric vehicles. As one option, embodiments of the present invention may be used to charge electric devices such as personal electronic devices such as cell phones, tablet computers, computers.

In the foregoing specification, the invention has been described with reference to specific embodiments; however, one of ordinary skill in the art appreciates that various modifications and changes can be made without departing from the scope of the present invention as set forth in the claims below. Accordingly, the specification is to be regarded in an illustrative, rather than a restrictive sense, and all such modifications are intended to be included within the scope of the present invention.

Benefits, other advantages, and solutions to problems have been described above with regard to specific embodiments; however, the benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” “includes,” “including,” “has,” “having,” “at least one of,” or any other variation thereof, are intended to cover a non-exclusive inclusion. For example, a process, method, article, or apparatus that comprises a list of elements is not necessarily limited only to those elements, but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. A holster for an electric charging station, the holster comprising:
a substantially rigid base;
a socket pivotably disposed in the substantially rigid base such that the socket has a first, stowed position and a second, engaged position, the socket pivoting about a loaded hinge; and
a biasing spring, the biasing spring producing a first force that urges the socket towards the first, stowed position, the biasing spring being one of a group including a coil spring, a leaf spring, and a toroidal spring.

2. The holster of claim 1, further comprising a guide slot disposed in the substantially rigid base and a guide nut attached to the socket, the guide nut being at least partially disposed within the guide slot.

3. The holster of claim 2, wherein the guide slot is curved.

4. The holster of claim 3, wherein the guide slot has a radius of curvature having its center co-located with the loaded hinge.

5. The holster of claim 2, wherein the guide nut includes a nut slot and the leaf spring is at least partially disposed in the nut slot.

6. The holster of claim 5, wherein the leaf spring is slidably disposed in the nut slot.

7. The holster of claim 1, wherein the holster includes a locking ledge.

8. The holster of claim 1, further comprising an electric power coupler at least partially disposed within the socket, the electric power coupler creating a second force, that is greater than the first force, which causes the socket to pivot about the loaded hinge, towards a second, engaged position.

9. The holster of claim 8, wherein the electric power coupler includes a lock that engages the locking ledge when the electric power coupler is disposed in the socket.

10. The holster of claim 1, wherein the socket is one of translucent and transparent.

11. The holster of claim 10, further comprising a light source capable of illuminating the socket.

12. The holster of claim 1, further comprising a sensor that detects a position of the holster within the substantially rigid base.

13. The holster of claim 12, further comprising a controller operatively connected to the sensor.

14. The holster of claim 1, further comprising a housing of an electric vehicle charging station.

15. An electric vehicle charging station comprising:
a main housing;
an electric charger connector and a charger cable attached to the main housing;
a controller;
a user interface disposed in the main housing and operatively connected to the controller; and
a holster disposed in the main housing, the holster including a substantially rigid base, a socket pivotably disposed in the substantially rigid base such that the socket has a first, stowed position and a second, engaged position, the socket pivoting about a loaded hinge, and a leaf spring, the leaf spring producing a first force that urges the socket towards the first, stowed position.

16. The electric charging station of claim 15, further comprising a sensor that detects the position of the holster and communicates the position of the holster to the controller.

17. The electric charging station of claim 15, wherein when the electric power coupler is disposed in the holster, a weight of the electric power coupler creates a second force, that is greater than the first force, the second force urging the socket to move towards the second, engaged position.

18. The electric charging station of claim 15, further comprising a guide slot disposed in the substantially rigid base and a guide nut attached to the socket, the guide nut being at least partially disposed within the guide slot.

19. The electric charging station of claim 18, wherein the guide slot is curved and the guide slot has a radius of curvature having its center co-located with the loaded hinge.
